(19) United States
(12) Patent Application Publication
(10) Pub. No.: US 2019/0102709 A1
(43) Pub. Date: Apr. 4, 2019

(54) SYSTEMS AND METHODS FOR COORDINATING VENUE SYSTEMS AND MESSAGING CONTROL

(71) Applicant: INVIGHT, INC., Rockville Centre, NY (US)

(72) Inventors: Ricardo Andres Correa, Wantagh, NY (US); Robert Santucci, Rockville Centre, NY (US); Aneesh Simha Ashutosh, Weston, MA (US)

(73) Assignee: INVIGHT, INC., Rockville Centre, NY (US)

(21) Appl. No.: 16/151,023

(22) Filed: Oct. 3, 2018

Related U.S. Application Data
(60) Provisional application No. 62/567,586, filed on Oct. 3, 2017.

(51) Int. Cl. G06Q 10/02; H04L 12/58; G06Q 50/00; G06F 15/18

(52) U.S. Cl. CPC G06Q 10/02; H04L 51/32; G06F 15/18; H04L 51/24; H04L 51/16; G06Q 50/01

(57) ABSTRACT

Systems and methods for managing and coordinating data objects encoding events. The method comprises accepting definition of a group event and a venue for the event; defining a private communication channel for use by participants invited to the event; establishing communication with one or more venue fulfillment systems; triggering execution of participant requested functionality on the one or more venue fulfillment systems; accessing fulfilment information on the one or more venue fulfillment systems; and enabling at least one user device associated with at least one member of a participant group to access and execute functionality on the one or more venue fulfillment systems.

### RELATED APPLICATIONS

This Application claims priority under 35 U.S.C. § 119(e) to U.S. Patent Application Ser. No. 62/567,586, filed Oct. 3, 2017, and titled “SYSTEMS AND METHODS FOR COORDINATING VENUE SYSTEMS AND MESSAGING CONTROL,” the contents of which are incorporated herein in their entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

Various conventional systems exist to schedule events and allow groups of people to interact with their social networks. Unfortunately, these calendaring and social sharing applications fail to address the complexity of managing and coordinating events, and fail to integrate with vendor systems to allow for custom and dynamic interactions at a venue or any provider event.

### SUMMARY

Accordingly various aspects of the present disclosure describe systems and methods for creating, organizing, and managing group events. According to one embodiment, the system is configured to automatically generate a private group communication channel for the participants, integrate with vendor operated point-of-sale systems, facilitate service delivery during an event, customize service delivery during the event, provide custom options or offers preceding an event, and may include generating custom options or offers (e.g., custom menu options, custom service offerings, etc.) dynamically during an event.

According to some embodiments, the system and methods for event management are configured with a layered or modular architecture. According to one embodiment, the layered architecture is especially configured for extensibility. In one example, a core system for event management provides a user application (e.g., via a mobile device) on which an event manager or event group leader can build an event, manage participants, and utilize an automatically created communication channel that is keyed to the participants and the respective event. In one example, the group and event based communication channel gracefully expires 24 hours after conclusion of the event so no further message blasts frustrate or annoy the event participants. In various embodiments, participants may be dynamically added or deleted via the group and event based communication channel.

According to another embodiments, the system, methods, and layered architecture is configured to provide functions via an extensible mobile application. The mobile application can include the core functionality above, and also be configured to: manage a participant list; assign payment responsibility across a group; enable individual ordering by participant (and even execution at integrated venues) before, at, and during the event; track individual ordering in real time to assign payment responsibility; enforce minimum tipping rules (e.g., set by default or set by event manager/group leader); secure discounts offered by the venue; access event tailored menus through POS/ordering system integration; transition between event tailored options and conventional offering based on user selection; enable new architecture for virtual VIP services (e.g., instead of VIP sections, the system and POS/ordering system integration allows event participants to request VIP status, and the venue can recognize virtual VIPs, provide faster service, offer additional services, without the conventional restrictions of the “velvet” or “red rope”); enable venues to propose candidate events and either execute the proposed event based on sufficient interest or cancel a proposed offering without incurring the actual costs of executing a specific event at the venue (e.g., improving the efficiency of the management system over conventional approaches); and/or provide deep learning analytics on event execution, proposed events, etc. Various embodiments of the extensible management system provide any one or more or any combination of the above features as extensible options. The extensible options can be added into and existing applications or used to upgrade an existing application as desired or needed.

It is realized that conventional implementations fail to integrate mobile applications directly to local execution systems (e.g., local venue architecture (e.g., POS systems, ordering systems, etc.)). Various embodiments of the system provide direct communication channels to local architecture, enabling functionality not provided in conventional approaches. Moreover, various embodiments, augment the direct communication with a mirrored information pathway to a central system. The mirrored pathway enables capture of additional contextual information, that can be used by the central system to enable additional functionality over conventional approaches (e.g., centrally track user allocation of activity even where local architectures do not provide user based granularity in tracking and functionality).

Some embodiments are directed to a management system that includes at least one processor operatively connected to a memory, the at least one processor configured to execute a plurality of system components. An event generation component, executed by the at least one processor, is configured to accept definition of a group event, manage participants invited to the event, and define a venue for the event. A communication component, executed by the at least one processor, is configured to define a private communication channel for use by the participants invited to the event. An integration component, executed by the at least one processor, is configured to: establish communication with one or more venue fulfillment systems; trigger execution of participant requested functionality on the one or more venue fulfillment systems; access fulfilment information on the one or more venue fulfillment systems; and enable at least one user device associated with at least one member of a participant group to access and execute functionality on the one or more venue fulfillment systems through the integration component.

According to one embodiment, the communication component is configured limit communication functions within the private channel to participants accepting an invitation to the event.

According to one embodiment, the communication component is configured to automatically terminate communication functionality based on a threshold time period after the event (e.g., 24 hours, 12 hours).

According to one embodiment, the system further comprises a user interface component configured to generate displays for accepting definition of an event, the definition of the event comprising one or more of date, time, venue, and participant list.

According to one embodiment, the user interface component is configured to modify default displays on a group leader device responsive to determining temporal thresholds associated with the event are met (e.g., UI is dynamically altered to new views based on the event being one hour away, two hours away, three hours away, etc.).

According to one embodiment, the user interface component is configured to generate venue displays on respective user devices associated with participants in the event group.

According to one embodiment, the system further comprises a customization component configured to accept user customizations for triggering venue functions, the customizations comprising one or more of custom drink recipes, and custom filters for the custom recipes.

According to one embodiment, the user interface component is configured to dynamically generate UI elements associated with the customizations, that are responsive to selection in the UI to trigger the customized functions on the one or more vendor fulfillment systems.

According to one embodiment, the system further comprises an analytic component configured to provide summary data or machine learning patterns on aggregate or individual event group data.

According to one embodiment triggering execution of a participant requested functionality comprises triggering placing of one or more of a drink order, a food order, and a service request.

According to one embodiment, accessing fulfilment information comprises accessing one or more of provider details, bartender information, occupancy information, comp offerings, menu selection, and options for service upgrades.

Some embodiments are directed to a method for managing and coordinating events. The method comprises using at least one computer hardware processor to perform: accepting definition of a group event and a venue for the event; defining a private communication channel for use by participants invited to the event; establishing communication with one or more venue fulfillment systems; triggering execution of participant requested functionality on the one or more venue fulfillment systems; accessing fulfilment information on the one or more venue fulfillment systems; and enabling at least one user device associated with at least one member of a participant group to access and execute functionality on the one or more venue fulfillment systems.

According to one embodiment, accessing the fulfilment information comprises obtaining venue occupancy information for the venue from the one or more venue fulfillment systems.

According to one embodiment, the method comprises determining an estimated wait time for a venue based on geolocation information and check-in information associated with the participant group.

According to one embodiment, the method comprises tracking review information obtained from the participants, the review information comprising one or more characteristics describing the venue.

According to one embodiment, the method further comprises dynamically updating inventory and staffing information for the venue based at least in part on an estimated occupancy level determined for the event.

According to one embodiment, accessing the fulfilment information comprises obtaining one or more deals or menus dynamically tailored to the participant group or group event.

According to one embodiment, the method further comprises tracking one or more orders placed by one or more members of the participant group.

According to one embodiment, the method further comprises tracking charges allocated to each of the one or more members for the one or more orders.

Some embodiments are directed to a non-transitory computer-readable storage medium storing processor-executable instructions that, when executed by at least one hardware processor, cause the at least one hardware processor to perform a method for managing and coordinating events. The method comprises: accepting definition of a group event and a venue for the event; defining a private communication channel for use by participants invited to the event; establishing communication with one or more venue fulfillment systems; triggering execution of participant requested functionality on the one or more venue fulfillment systems; accessing fulfilment information on the one or more venue fulfillment systems; and enabling at least one user device associated with at least one member of a participant group to access and execute functionality on the one or more venue fulfillment systems.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “ this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of an example management system, according to one embodiment;

FIG. 2 shows an illustrative user interface including a discover screen 200 via which a venue may be located and reviewed, in accordance with some embodiments;

FIG. 3 shows an illustrative user interface including a friends screen 300 that allows communication among friends, in accordance with some embodiments;

FIG. 4 shows an illustrative user interface including an invite screen 400 via which users can be invited to events, in accordance with some embodiments;

FIG. 5 shows an illustrative user interface including a deals screen 500 via which deals or offers can be presented and selected, in accordance with some embodiments;

FIG. 6 shows in illustrative user interface including a menu screen 600 via which menu selections can be made, in accordance with some embodiments;

FIG. 7 shows an illustrative user interface including a validation screen 700 via which group orders and expenses can be tracked, in accordance with some embodiments;

FIG. 8 shows an illustrative user interface including a screen 800 via which a tab can be opened at a venue, in accordance with some embodiments;

FIG. 9 shows an illustrative user interface including a summary screen 900 for a user, in accordance with some embodiments;

FIG. 10 shows an illustrative user interface including a venue profile screen 1000 via which information associated the venue can be obtained, in accordance with some embodiments;

FIG. 11 shows an illustrative visual representation of group data and offered deals, in accordance with some embodiments;

FIG. 12 shows an illustrative visual representation of information associated with individuals or groups checked in a venue, in accordance with some embodiments;

FIG. 13 shows an illustrative visual representation of information associated with deals offered by a venue, in accordance with some embodiments;

FIG. 14 shows an illustrative visual representation of demographic information for a venue, in accordance with some embodiments;

FIG. 15 shows an illustrative visual representation of historical information for a venue, in accordance with some embodiments;

FIG. 16 shows an illustrative visual representation of summary data for a venue, in accordance with some embodiments;

FIG. 17 is a block diagram of an example management system, according to one embodiment; and

FIG. 18 is a schematic diagram of an exemplary computer system that may be specially configured to perform processes and functions disclosed herein, according to one embodiment.

### DETAILED DESCRIPTION

According to various embodiments, an event management system is executed via a mobile application and integration with vendor or provider specific systems. According to one embodiment, the mobile application provides an interface for an event manager or event group leader to define an event, invite participants, track responders, register payment information and engage a venue, including accepting offers specific to event groups, and/or specific to a particular event group. According to another embodiment, the system provides an interface for venues/providers to interact with participant groups, tailoring offers to the group, even bidding on event groups to attend their venue, tailoring menu options to the event group, and/or enabling custom ordering/menus to the event group, among other options.

According to further embodiments, the system is configured with an extensible architecture and is configured to provide basic functions in a base configuration (e.g., group leader functions (including, for example, event definition, invitation, participant tracking, payment registration, ordering functions, tab/payment tracking, and bill reconciliation with venue point-of-sale (POS) systems). Extensible functions can be added to system or mobile application as desired, for example, to provide venue or provider specific functions, including for example, custom ordering options for an event group, virtual VIP services for events groups or individuals, or deep event analytics. Other extensible functions can include venue profiles (e.g., characteristic tracking of a venue and individual/group matching), server or provider profiles (e.g., bartender profiles and tracking of characteristics of servers on a venue basis, and or an individual basis, as well as entertainer profiles (e.g., VJ profile, characteristics, etc.).

In some settings, the system provides a group communication channel that can be tied to a venue (e.g., via an associated venue profile) to provide real time information (e.g., occupancy information, venue views, expected wait time, etc.). In some examples, a venue limited communication channel can be enforced by the system, that requires proximity (e.g., around or within the venue) based on location signals in order to participate in the communication channel, among other options. In further examples, the system can manage restrictions on the communication channel so the executed restrictions are selected based on time. In one example, location (e.g., in the venue) restrictions can be enforced just prior to and during the timing specified for an event, among other options. In various embodiments, temporal execution of communication restrictions improves execution efficiency of the system (e.g., based on eliminated outside communication, when system resources should be focused on the actual event participants).

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

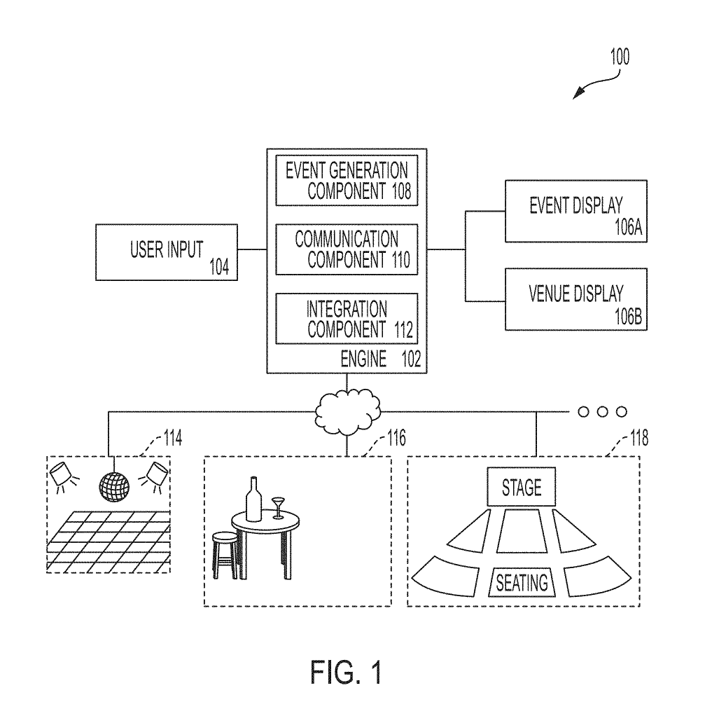

FIG. 1 is a block diagram of an example event management system 100. The event management system can include an event management engine 102 configured to execute the various functions disclosed herein for managing and/or executing group events. According to one embodiment, the event management engine 102 encompasses a mobile application, which can be installed, for example on a mobile device and/or mobile phone. In some embodiments, the event management engine 102 is configured to execute on a server device and communicate with one or more mobile applications executing on one or more mobile devices associated with one or more users, such as, group leaders, group participants, promotors who utilize the system to organize events for particular venues, and/or other users. In some implementations, the event management engine 102 is configured to serve as a web-based backend for one or more venues that register with the system and to allow the registered venues to view and manipulate information associated with the group and associated event (e.g., deals, placed orders, tabs, etc.).

The event management engine 102 can include a plurality of system components or can be specially configured to execute the disclosed functions without instantiating any particularized component. According to one embodiment, the system and/or engine includes an event generation component 108 configured to generate a group and associated event. According to various embodiments, the user building the event on the system (e.g., 100) is designated the event group leader. Responsive to user input 104 (e.g., via a mobile application executing at the user's mobile device), the engine 102 and/or event generation component 108 is configured to define a group event (e.g., dinner out, bar hopping, girls' night, pool hall, dancing, concert, etc.) and include selected participants (e.g., user input, system recommended, preference matching etc.). The engine and/or generation component can also be configured to access profile information on the group leader and automatically suggest participants based on historic selection, associations to the group leader, preference of the associated participants, etc. In some embodiments, the system can include application programming interfaces (APIs) to enable access to the group leader's social contacts to provide as recommendations or capture as part of the group leader's profile.

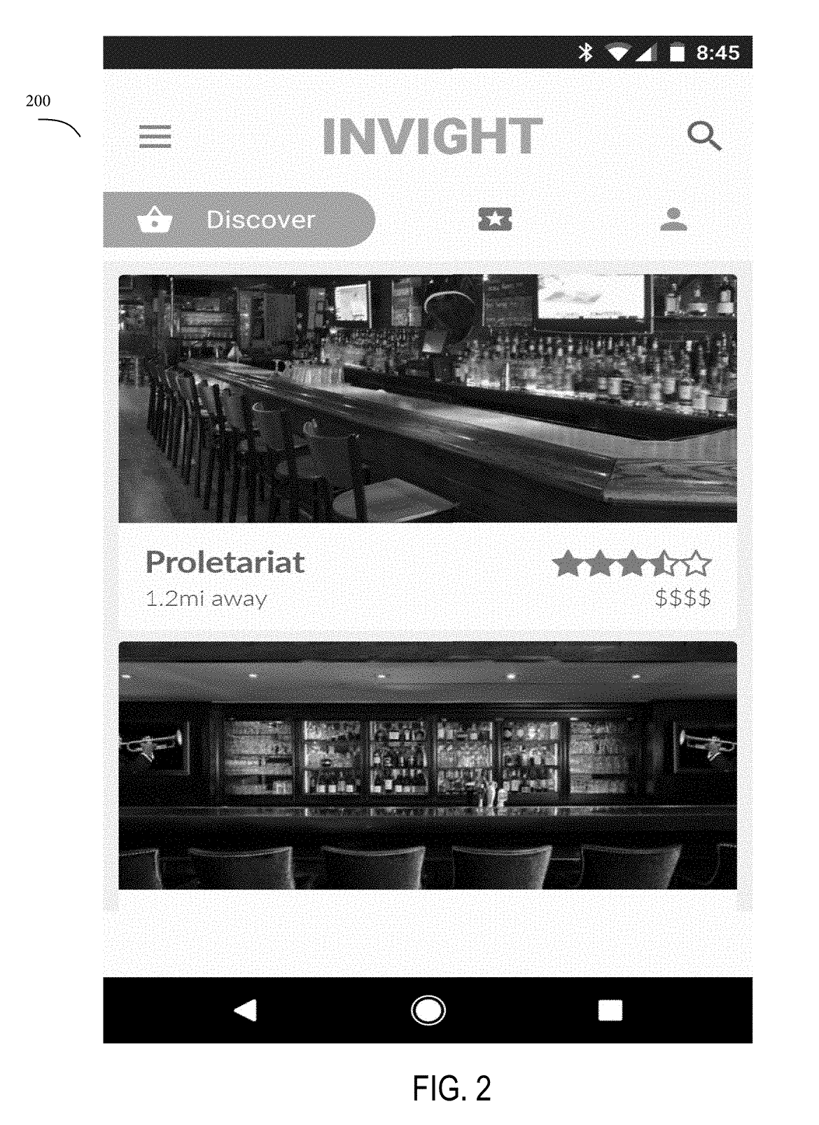

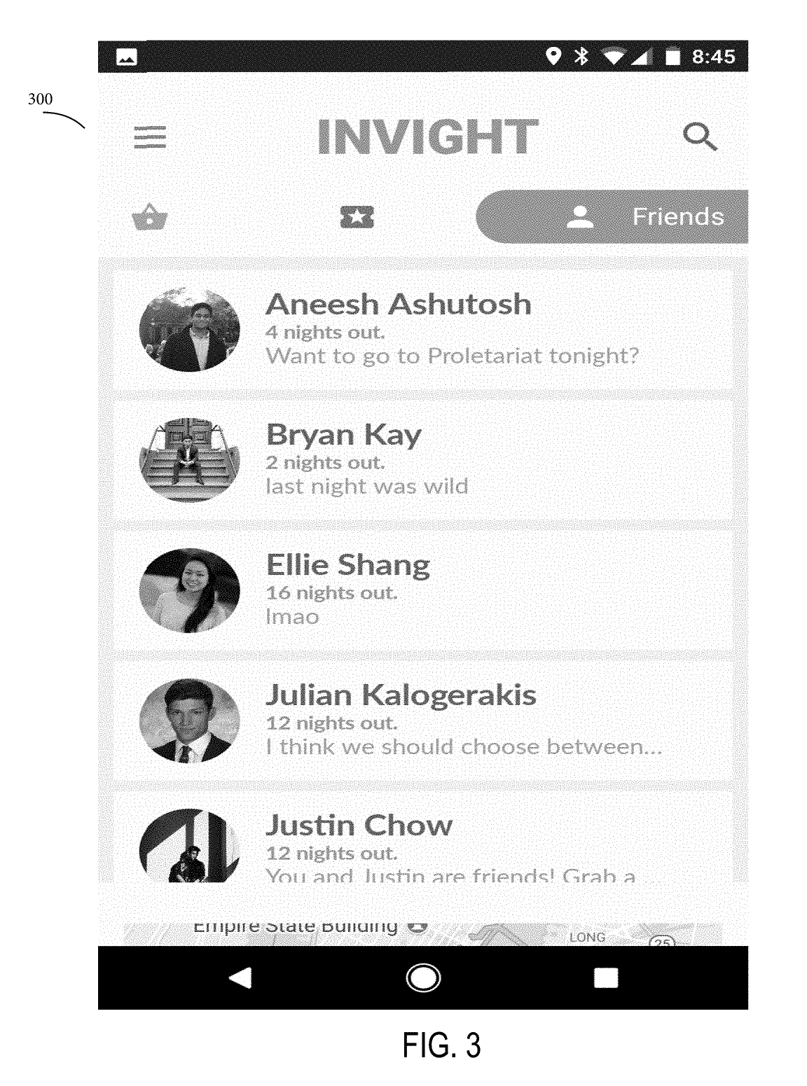

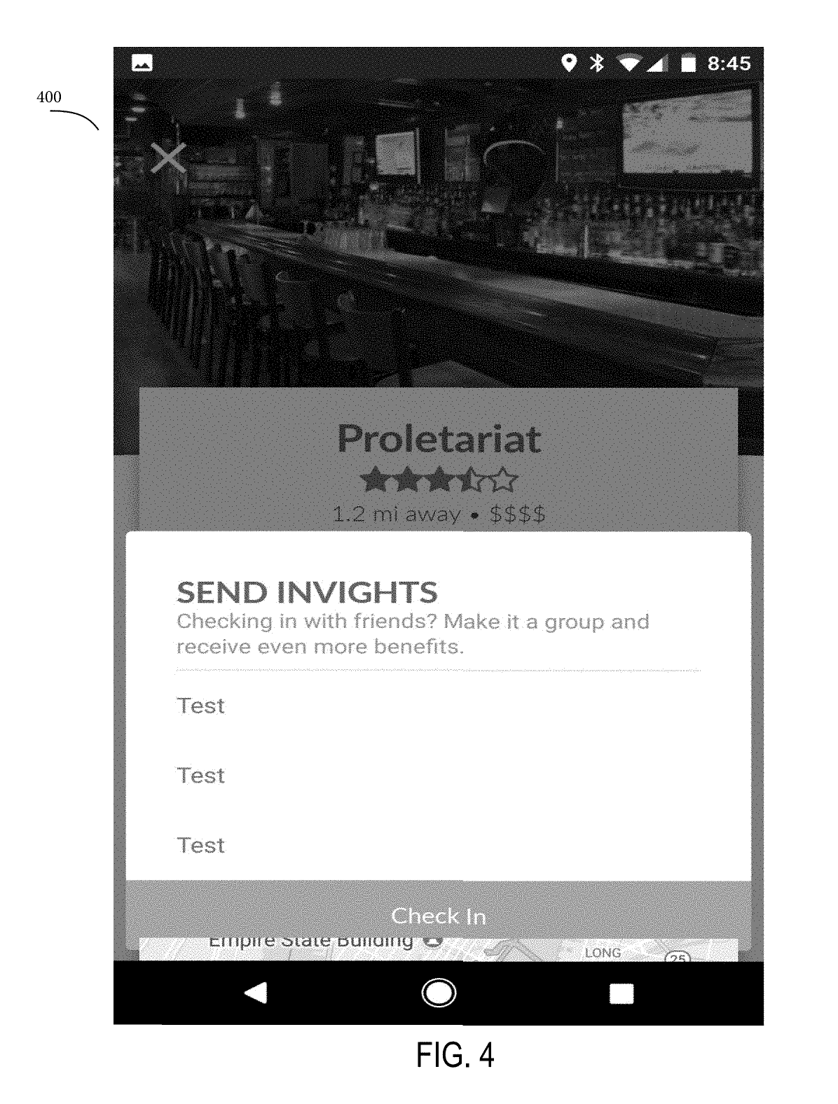

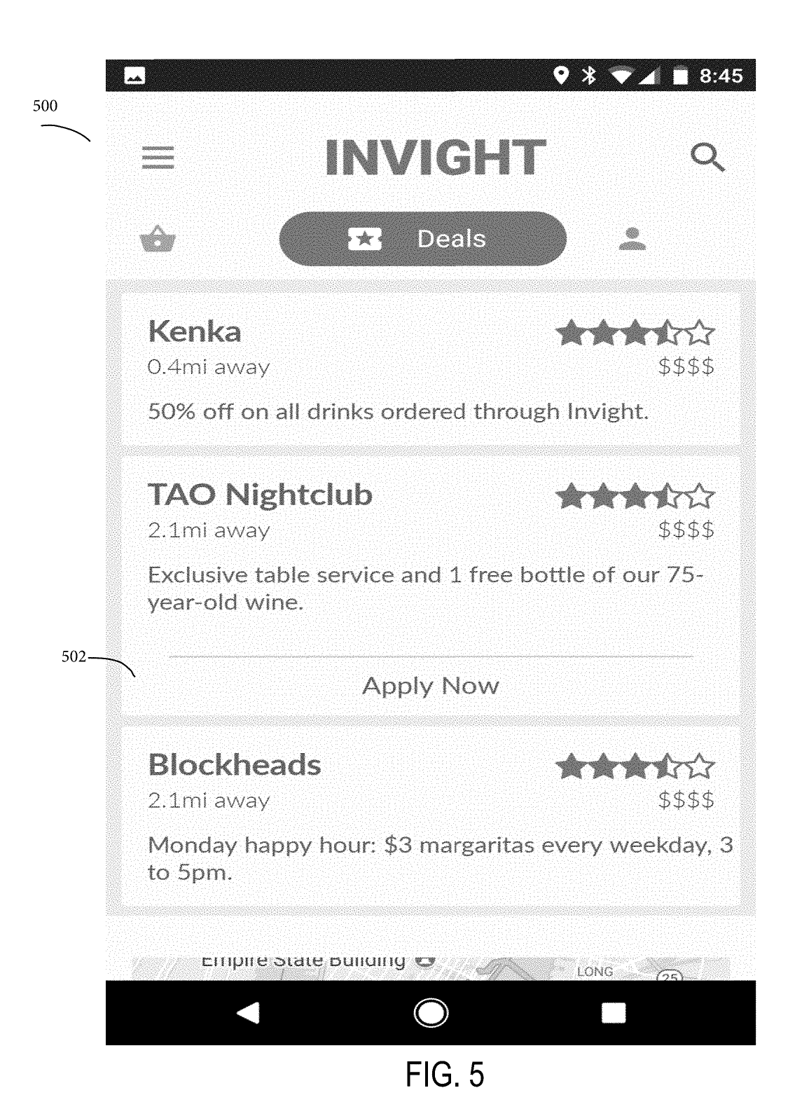

According to some embodiments, the system enables the event group leader to define a participant list and an event description (including, for example, time, place, etc.). For instance, the group leader may discover a particular venue of interest via a discover screen 200 displayed in the user interface shown in FIG. 2 and invite friends to the venue by sending messages via a friends screen 300 (FIG. 3) or invites via an invite screen 400 (FIG. 4). The group leader can engage various venue options through the system, and select venues that provide the best options (e.g., reduced menu pricing, free bottle of champagne, VIP service, enhanced menus, etc.) to the potential group. In some embodiments, the system determines a group value and communicates the estimated value of the group to potential venues. In some settings, the system enables competitive “bidding” for hosting the event and/or group to entice a particular group leader to attend a respective venue. Typically, the venue systems can provide various comps or deals (as shown in FIG. 5) or special menus tailored to group events, and the group leader can select a comp or offer they desire. For example, the group leader may select venues based on comps, offers, or deals presented via a deals screen 500 displayed in the user interface shown in FIG. 5. The deals may be include deals that are dynamically tailored to the group leader (e.g., based on the group leaders event history, participant profiles, spending history, tipping history etc.) and/or generally applicable to various users of the system. Once a deal selection is made, such as by selecting an “Apply now” button 502, the invitees/participants in the group may be notified of the selection via a private communication channel described in further detail below. The notification may include specific participation rules or requirements, which may include a minimum tipping percentage, payment options (e.g., pay ahead of time for an open bar or at the end of the event), and/or other requirements. In further embodiments, the group's and/or event's value can be dynamically determined by the system (e.g., based on the group leaders event history, participant profiles, spending history, tipping history etc.) and updated as various participants (e.g., invitees) accept and/or commit to attend an event. In some examples, the dynamically determined values can provide increasing access to more valuable offers or comps. In further embodiments, the system can be configured to notify a group leader (e.g., via communication component 110) as their group value increases, triggering more valuable offers or comp packages (e.g., responsive to participants accepting or committing to an event).

According to further embodiments, the system is configured to automatically build and enable a private communication channel between the invited participants in the event group. In one example, the system 100 and/or engine 102 includes a communication component 110 configured to instantiate a private communication channel between the members of the event group. For example, each member of the event group can message any other member within the private channel, and can also message the group or subsets of the group. Via the communication channel the group leader can manage the specifics of an event, soliciting input and tracking votes or options for selecting a venue for the event. Various user interfaces are made available on the system to facilitate accepting participants, tentative participants, and declining participants (e.g., with event display 106A generated by the system 100 and/or engine 102). In various embodiments, the system maintains a participant list in real time, and through interactions with various venue systems communicates the real time participant list. In various embodiments, the system and venue integration enables dynamic and real time participant lists that cannot be achieved with conventional systems. For example, the system and/or engine can include an integration component 112 configured to interact with venue computer systems. In another example, the integration component 112 can include a number of APIs that communicate directly with venue point of sale system, ordering system, ticketing system, reservation systems, etc. In some implementations, the system is configured to automatically enable direct communication with the venues/venue systems for the group leader.

According to various embodiments, system defaults can be configured to control sharing of information between the system and integrated venues. The group leader as administrator of the event can alter any default settings. For example, the group leader may require his/her approval before a participant is added to a guest list—thus even dynamic and real time guest lists for an event can be managed by the group leader.

In other embodiments, the event group leader can also manage or restrict group communication based on configuration settings on the system. For example, only the group leader can generate group messages settings on the application (or via the communication component 110) to limit message distribution. Ensuring only needed messages are sent to the group can limit user frustration over various conventional approaches—various conventional messaging systems generate too much irrelevant message traffic (e.g., wasting processing, memory, and bandwidth) and wasteful network traffic. Enabling group leader based communication filters and/or constraints on the system achieves more efficient a communication channel and a more efficient overall system when compared to conventional messaging applications.

According to one embodiment, the system can be configured to present temporal based functionality. For example, prior to the event, the system is configured to present event generation and management user interfaces (e.g., 106A) and associated functions. The management interfaces and associated functions streamline the creation and participant subscription to the event or groups. As the time for the event approaches, the system is configured to present different user interfaces, not only to the group leader but also to the participants of the event. For example, as a scheduled event approaches the system can be configured to switch from displays associated with starting or promoting an event, to options for selecting entertainment at the event or menus options for ordering at the event (including pre-ordering menus options, drinks, upgrading service, etc.).

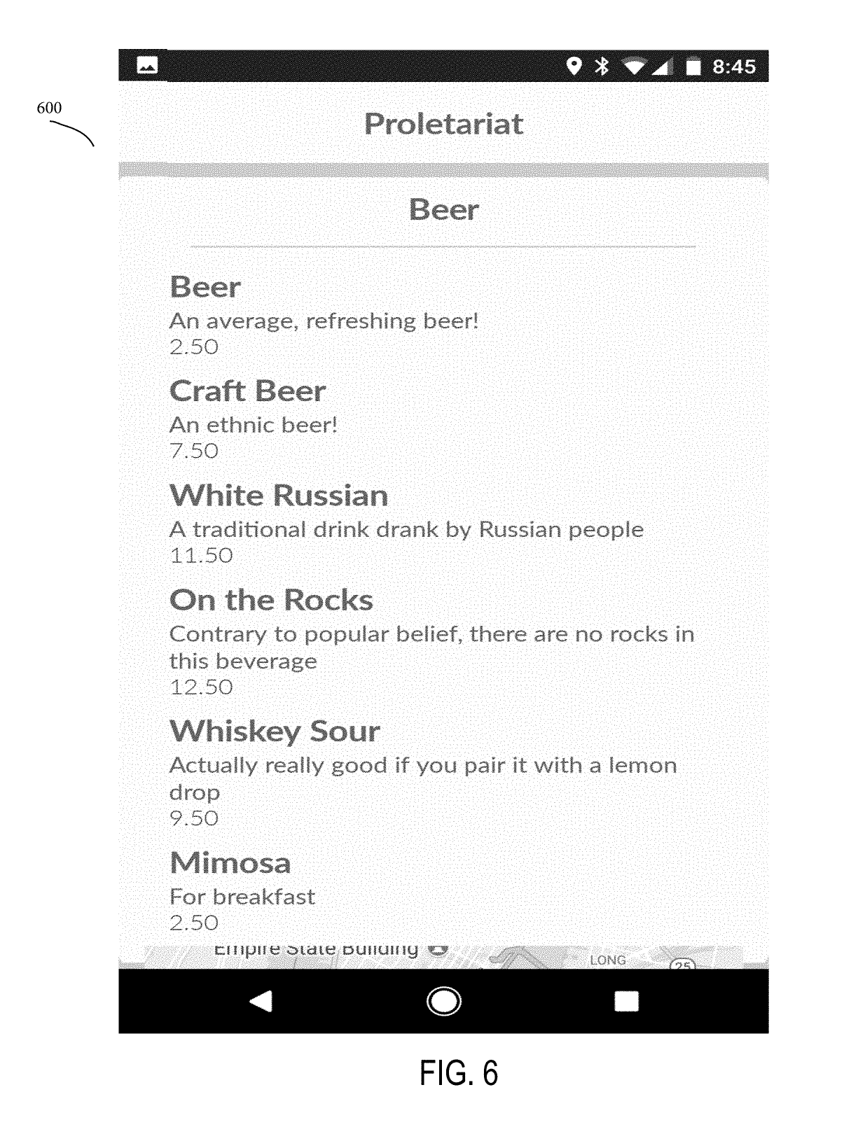

According to one embodiment, the system and/or integration component 112 is configured to access point of sale (POS) systems and/or ordering systems for the event venue and display venue tailored user interfaces through the system and/or application on the user devices. Various embodiments, provide an unique architecture not found in many conventional approaches, where direct interaction can be executed between an application executing on a mobile device and the local system architecture (e.g., POS systems). In some implementations, the integration can include presenting tailored menus for a specific venue via a UI (as shown in FIG. 6, for example) at the user devices. The group leader/participants may place their drink orders via the UI provided at their respective devices by, for example, selecting a number of drinks of a certain type via the UI. In some implementations, the integration component 112 may track the placed orders and communicate the orders to the POS system/ordering system for the venue. In other implementations, while the integration component 112 may track the placed orders, the orders may be communicated directly from the user devices to the POS system/ordering system for the venue. In some aspects, the placed orders may be delivered directly to devices handled by or otherwise available to bartenders at the venue. The bartenders may, via the devices, indicate when the order is fulfilled, which can cause a notification to be communicated back to the users who placed the orders at their respective devices, thereby substantially reducing inefficiencies associated with conventional ordering systems.

In addition, the system allows for image-based verification to be used thereby increasing accuracy of the order placement and fulfillment process. For instance, when the orders are communicated to the bartender devices, each order may be associated with a picture of the individual who placed the order, thereby preventing orders to be delivered to unintended users. In other aspects, the system may be further improved by reducing user error by ensuring that both the user and the bartender are aware of the rules associated with the event. For example, for an open bar event occurring from 7-9 pm with a limited selection of drinks, both the user device and the bartender devices may track the timing, number, and type of drinks ordered to ensure that the orders are fulfilled in accordance with the rules for the open bar event.

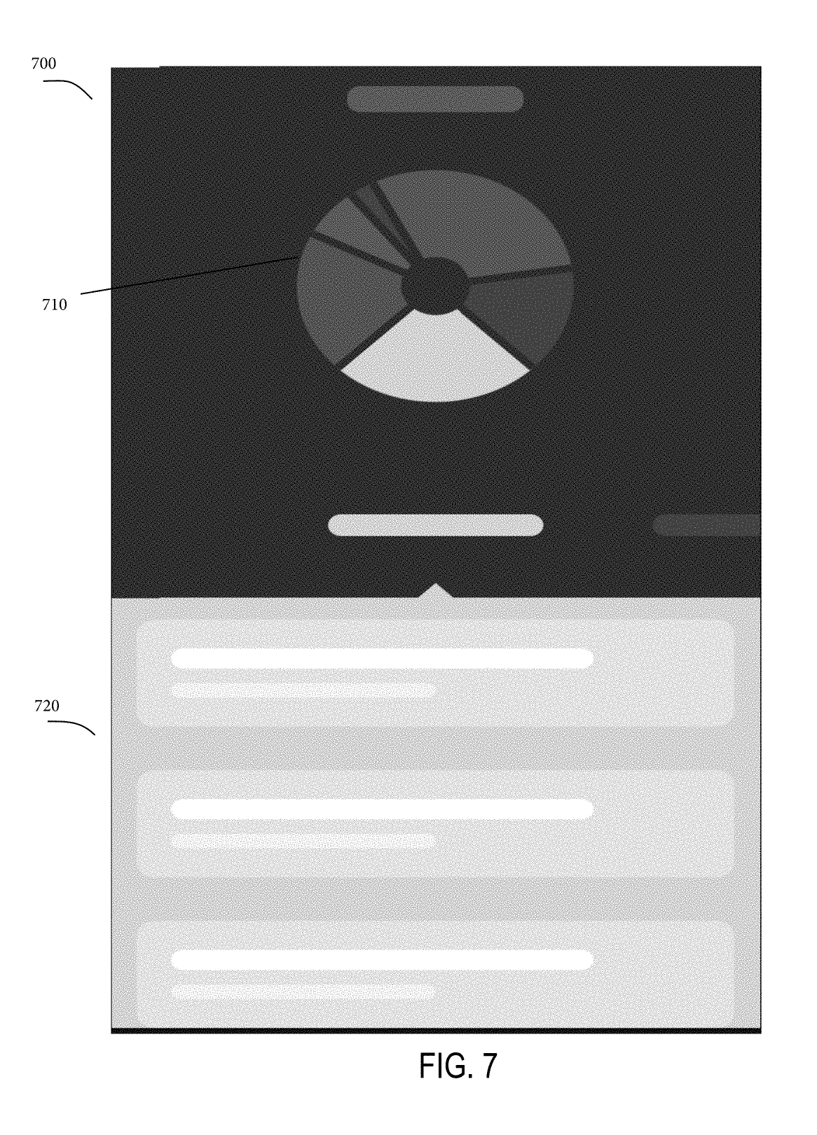

According to some embodiments, the integration component 112 may maintain information associated with the placed orders, such as number of drinks ordered by each user in the group, charges for each user in the group and present dynamically updated information via a UI shown in FIG. 7 and described in more detail below. The point of sale system, on the other hand, may maintain aggregated data associated with placed orders for the entire group instead of orders placed by each individual in the group. Providing an aggregate data container at the native POS system while maintaining detailed information regarding associations with various individuals of the group at the management system results in significant reduction in data/storage resource usage at the POS system thereby improving efficiency over conventional systems.

In some embodiments, the integration can include communication of location based signals from a user device to the POS systems and/or ordering systems so that a venue operator can provide VIP service to participants in any location at a venue. Unlike conventional implementations or systems, venue hosts and/or services can locate VIP event members based on location signals communicated to their own systems by the user's devices (e.g., through the integration component). Based on the management system architecture and integration with the venue systems, current embodiments provide vastly enhanced access and targeting even in settings where conventional approaches would fail to operate.

The enhanced targeting provided by various embodiments, enabled even singular members of an event group to elect VIP status or to make additional payments through the venue tailored UIs (e.g., 106B) to received enhanced service. Additionally, even for venue locations that do not have VIP rooms or VIP sections—an individual user can be identified and their service upgraded responsive to synergy created in integrating the management systems and the venue's systems. The options for venue selection and integration with the same is virtually unlimited (e.g., dance clubs 114, bars 116, concerts 118, restaurants, pool halls, sporting events, sports bars, among other options). For example, the integration component can include any number of APIs configured to interact with common vendor systems, common ordering systems.

Where enabled or available, the management system can be configured to communicate with venue computer systems to identify the event group and access tailored menus or service offerings tailored to the event group. In one example, the tailored menus include menus with different pricing from other guests of the venue. In further examples, the management system can communicate various state settings associated with the group that trigger access to enhanced offering from the venue.

According to one embodiment, the management system is configured to handle payment by the member of the group. In one example, each purchase by the group is tracked on the management system, and allocated to various group participants in custom displays on each users' device. In some settings, the system can enforce minimum tipping requirements on each participant in the event group. For example, the group leader can establish participation rules which include a minimum tipping percentage. In some embodiments, such guarantees enforced by the system are used to establish states that are communicated to venue systems, which validate associated state information. Responsive to passing the validation check, enhanced user interface features can be presented or made accessible to the participants of the group on their respective devices.

The system can also be configured to consistently check other requirements for group participation. In one example, the system requires valid payment information to join or accept an invitation to an event group. Periodic, aperiodic, and or continuous validation can be executed by the system to ensure no member shirks responsibility for their portions of a group tab for any event. In further examples, the system can be configured to shut down user access to the venue tailored UIs, ordering functions, etc. (e.g., 106B) responsive to a failed re-validation of payment information. In another example, the system is configured to limit display to the end user to screens for capturing updated payment information. In some other examples, the event group leader is notified on their respective device of the failed payment validation of any member.

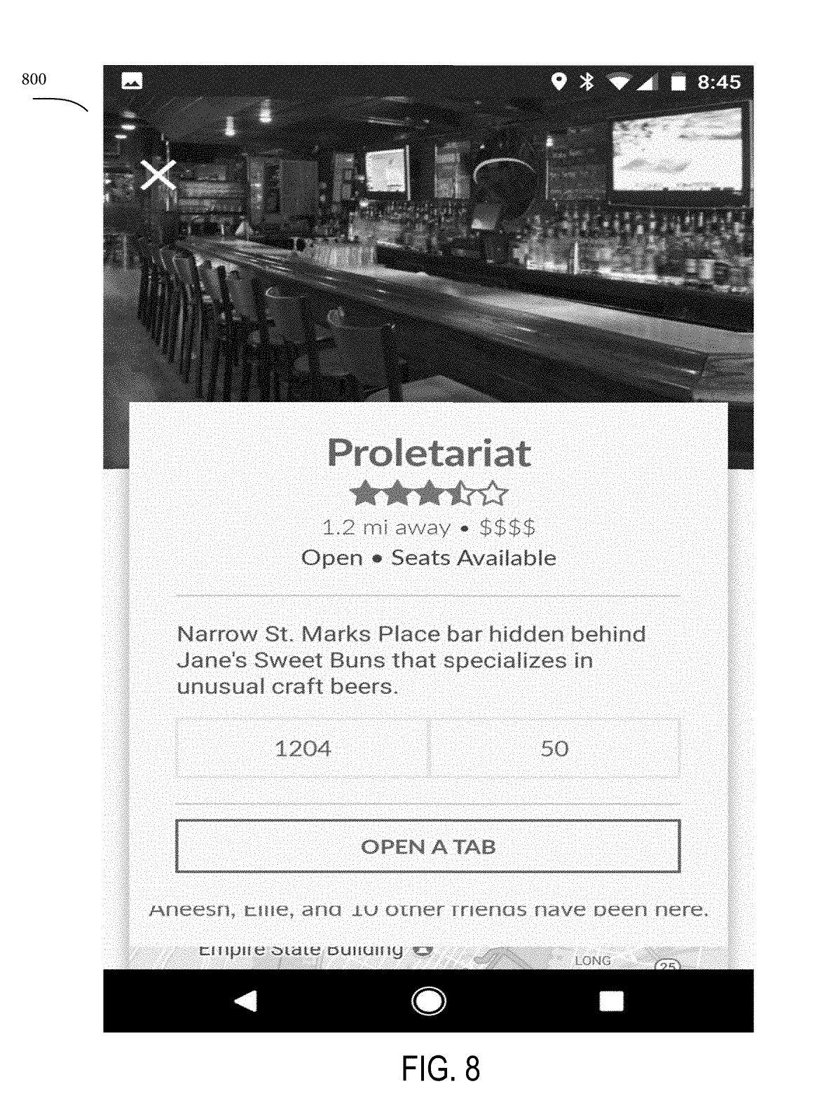

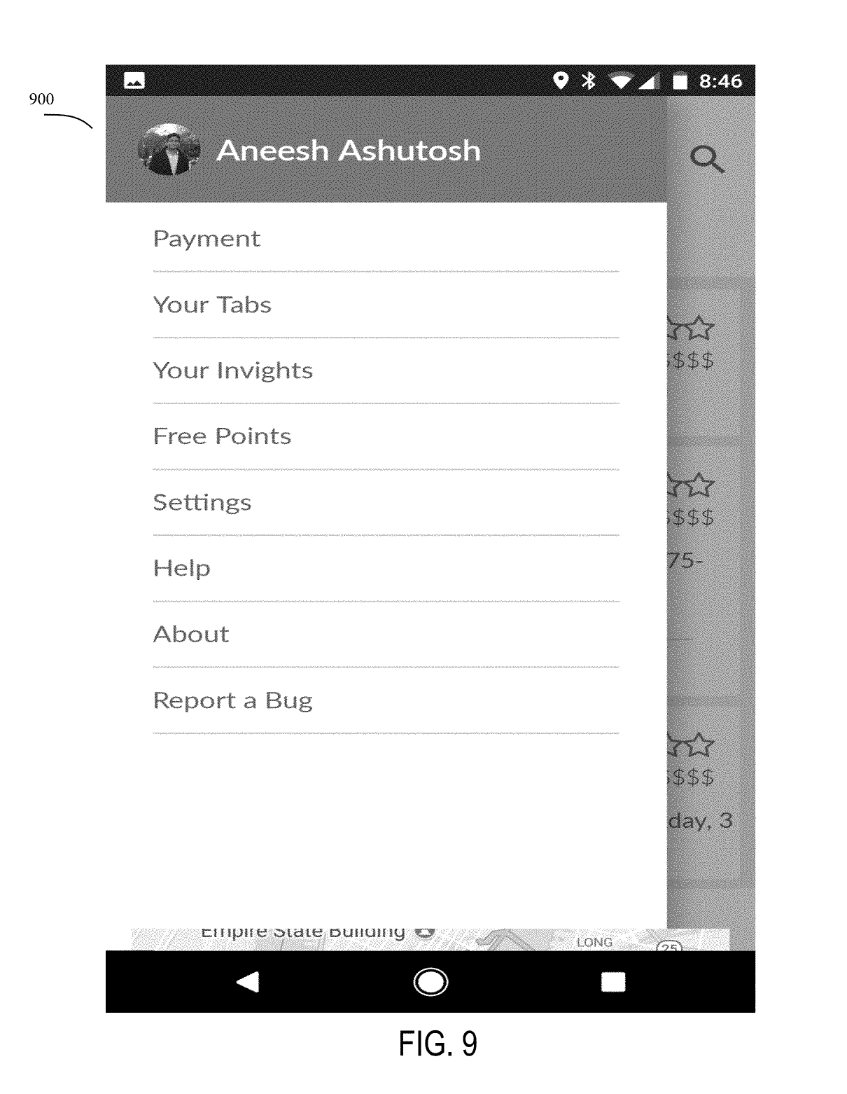

According to various embodiments, the group leader ensures valid distribution of group charges via user interfaces specific to the group leader. For example, the system can be configured to track the orders placed by various individuals in the group (e.g., on a device or account basis) and display a validation screen to the group leader to approve the groups expenses for the event. The validation screen can be configured to accept input from the group leader to re-allocate individual charges, re-allocate dollar amounts, set percentages per individual users, allocate complimentary offers within the group, control enhanced service settings for users, etc. FIG. 7 is an example screenshot of a validation screen 700 displayed to the group leader/participants via a user interface, although a similar screen may be displayed to the group leader/participants when the group leader opens a tab at the venue (via screen 800 of FIG. 8) without departing from the scope of the disclosure. The validation screen includes a pie graph 710 that can show allocations between users, and selection in the UI of a pie graph section enables the group leader to view charges assigned to specific users. In some embodiments, each pie graph section corresponds to an individual in the group, and selection of the pie graph section enables a group leader to view the orders placed by and/or associated charges for the respective individual, for example in a portion 720 of the validation screen below the pie graph 710. In some alternatives, the UI can be configured to display portions of charge assignments across the user group (e.g., % of bill) and the group leader can expand or contract the pie graph sections in the UI to re-allocate payment. In one embodiment, the validation screen includes a user selectable graphical element (e.g., a button) in addition to the pie graph, and selection of the element enables to the group leader to split the charges evenly between the users. In some embodiments, the system is configured to display a summary screen 900 (as shown in FIG. 9, for example) to the group leader/participants providing information, such as past or current tabs opened by the group leader/participants, past or current invites sent by the group leader/participants, payment information for groups associated with the group leader/participants, and/or points or deals available to the group leader/participants to redeem.

According to various embodiments, the management system is configured to receive a group leader approval of a total charge (including, for example, allocation of any tip within the group), and communicate the allocation of payment, payment information, and authorization information to a POS system at the event venue. The venue system can execute the charges and report the receipt back to the management system. In other embodiments, the management system can be configured to execute the charges against the individual user accounts and provider receipts or confirmation to venue based systems (e.g., POS systems).

In some environments, the interaction between the management system and vendor system includes tracking of all group activity to award points. According to one embodiment, the management system can automatically redeem group points (e.g., through the interface component 112) to enable access to enhanced functions on the vender system and/or special menus. In further examples, various point options can be managed between the management system and vendor systems to automatically allow special access, for example, to VIP areas or restricted access sections at a venue. In one instance, a group leader or group participant can redeem points in the management system to receive a backstage pass during an event. In some examples, real time accumulation of points and/or increase group valuation can enable such functions without the reconciliation operations needed by conventional approaches.

As discussed above, the management system can be configured to provide a base level or base group of functions to group leaders, venues, and/or participants. The base functions can be augmented, for example, based on configurations for a particular venue (e.g., point reward/tracking, complimentary menus/options, state track (including, for example, value tracking, offer tracking and redemption, bidding options, etc.). In some instances, any embodiment can be enhanced with the additional functions described herein or use any combination of the features, user interfaces, functions, bidding, analytics to improve to execution of the management system.

Further enhancements can include participant profiles, where individual users can either define their own event preference or accept a system generated profile associated with the user. In various examples, the event preference for the users can be defined for each event, group setting, venue, or venue category. In particular, where the venue is a bar, the user (e.g., participant or group leader) can define their own drink preference, including as desired any customizations for their drink preference. Upon accessing a venue the system can be configured to search the event group user profiles' and modify dynamically user interface displays to enable “my drink” options (e.g., selectable UI buttons labelled “My Martini,” “My Gimlet,” “My Favorite”—each can be associated with custom recipes and/or matching criteria (e.g., bartender, venue, etc.). Responsive to such selection in the UI, the management system communicates the custom order to the venue's systems for automatic execution and delivery to the user. Users can defined any number of custom orders that are displayed dynamically on the system responsive to matching the venue and any other customer parameters.

For example, one customization that can be set by the user is a provider filter or selection. A my bartender profile option can be defined on the management system. Responsive to matching the venue, the management system can automatically query the venues system to determine staffing information, and match further user customizations. If the venue, and for example, staffing information match, the system can display custom UI to the user, allowing them to place order exclusively with their bartender. In some embodiments, such options including custom user interfaces to access the functions, are limited by the system to those users having a minimum value or who have committed to a minimum tip percentage or minimum group spend amount. Thus, the system can tailor individual UI displays and associated functionality. According to various embodiments, the introduction of UI buttons to customize and enable user selection of options with pre-defined input increases the efficiency of the management system over conventional approaches. For example, linking UI buttons eliminates the acts of user input past the first instance, decreasing the processing time, input operations, and active memory consumed—and each such use amplifies the efficiencies of the system across users and UI selection instances.

Provider profiles within venues can also be automatically created and made accessible to the event participants. For example, bartenders can be associated with “heavy pour” tag (indicating more alcohol in drinks—which may allow some users to avoid and other users to prefer). The profile and characteristics can be developed by the system through targeted survey and/or data analytics. In some approaches, machine learning algorithms are used to evaluate venue data, ordering, trends, patterns, etc. indicative of positive or negative experience. The characterizations can be stored as venue associated profiles for subsequent users and/or event planning. Further provider profiles can be included and associated with specific venues and/or entertainers who transition between venues among other options.

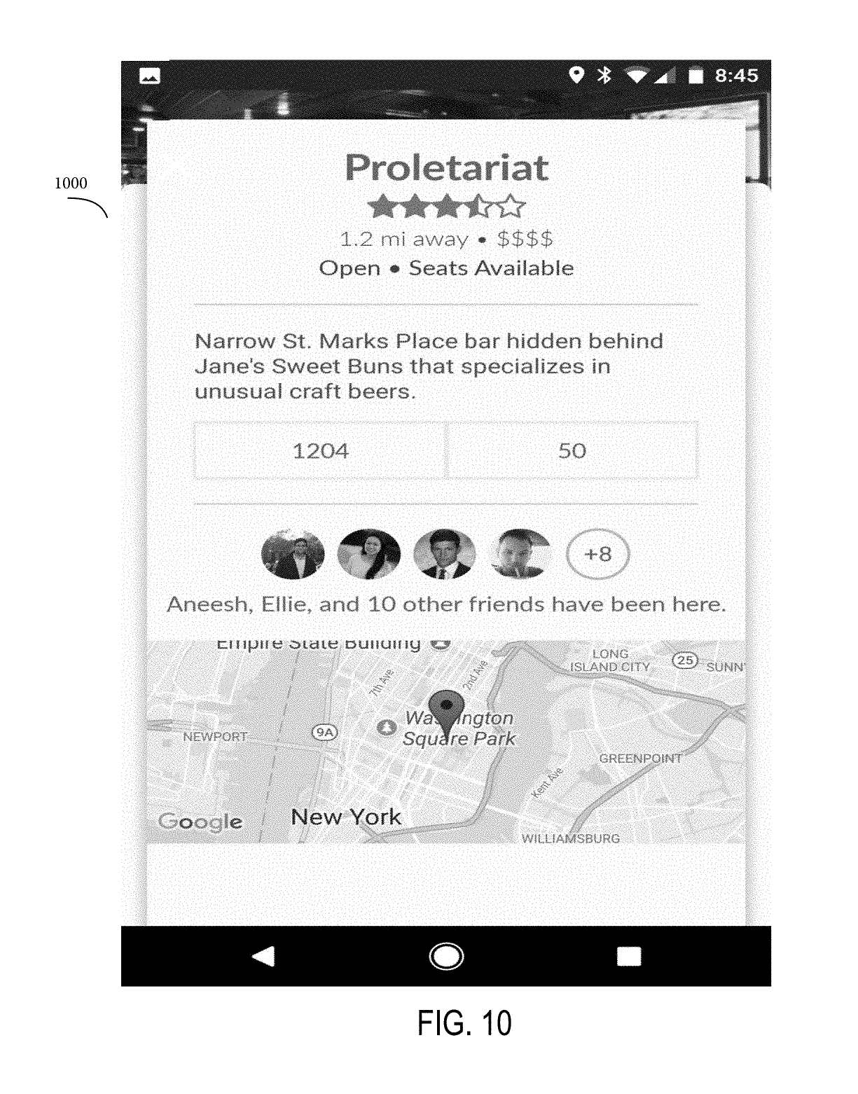

According to another aspect, the transition in the system from event management displays 106A to venue specific displays 106B can include real time views of specific venues. According to one alternative, real time displays of specific venues can also be accessed as part of event planning. For example, a group leader can review current views of a potential group venue, as shown in FIG. 10 that depicts a screenshot of a venue profile screen 1000, when organizing a spontaneous event. The real time view enables the group leader to determine occupancy of the venue, and the dynamic displays of the venue shown by the system can provide information on expected wait times, predicted wait time at the scheduled time for the event (e.g., later that night, five minutes, ten minutes, etc.), individuals known to the group leader who have been at the venue, a number of individuals (indicated as “1204” in FIG. 10) who have checked-in at the venue, and an aggregated percentage (indicated as “50”% in FIG. 10) indicative of occupancy level (for example, how full the venue is). In further embodiments, the system can organize displays of potential venues based on occupancy information, proximity, wait time, etc., or any combination the preceding. Over time the system can build profiles of venues to include predictive models of wait times, occupancy, etc. Advantageously, various embodiments of the system can evaluate real time views of a particular venues to validate the system based predictions. In some examples, the system can use view information to override predictive models and improve accuracy of the system based determinations, specifically over conventional systems that do not include hybrid analysis of modelling and real time information.

In some embodiments, the system can determine an average or estimated wait time for a venue based on geolocation and actual check-in time of individuals. The system may use geolocation techniques to determine that a user is within a particular distance or radius of the venue. The system may also determine how long the user took to check-in/order at the venue. For example, when the user is within a particular distance of the venue, the system may initiate a timer that is stopped when the user actually checks-in and orders at the venue. Such timing information collected across various individuals is aggregated and used to dynamically update the average wait time for the venue.

According to one aspect, the system may track the location of various users in the group, for example, based on location based signals from users' devices and provide notifications or updates to the group (e.g., via the private communication channel) regarding the occupancy level and the average wait time for a particular venue. Such enhanced information collected and provided by the system streamlines the venue selection process and enables selection of a venue having one or more characteristics desired by the group (e.g., average wait time of 10 minutes or less, occupancy level of 50% or less, etc.).

According to other aspects, the management system can also include venue management functions. In one embodiment, the management system is configured to evaluate venue visits scheduled by group leaders, users, etc. to provide more accurate predictions or determinations of use or occupancy. In a restaurant example, such early detection and improved accuracy on attendance can be immensely valuable for scheduling staff and other resources. In some embodiments, the management system can communicate user enrollment at various venues to the respective venues and can also communicate overall utilization predictions for the respective venues. In some settings, such utilization information can be used by respective management systems or applications installed at the venues to automatically call in additional support personnel (e.g., via text, e-mail, automated call, etc.).

Further aspects enable the system to reward users, group leaders, etc. with points based on system executed functions (e.g., check-in at a venue, use custom menu to order, use profile UI selection to order, etc.). Points can be used to qualify for comps (e.g., seats, service, VIP status, etc.) at various venues and the management system and respective venue system can manage status evaluation, offer presentation, crediting and debiting points without user intervention.

As discussed, various embodiments of the management system are extensible and/or modular. In some examples, venue specific “mods” are provided and configured to execute vendor specific functions. For example, the venues can build profile information on specific events—“ladies night,” “trivia night,” and/or “karaoke night,” among other options. In some embodiments venues can use the management system to promote candidate event nights. Virtualizing such events through the management system eliminates the inefficiencies of conventional systems/approaches where a venue has to actually host an event to determine performance. Under the management system, venues can collect actual attendance information far in advance of hosting a “real world” event—such simulation of group event nights eliminates the waste associated with conducting sparsely attended events. In some settings, the management system can automatically cancel such potential failed events. Further the system can announce and promote potential events until minimum attendance (including, for example, predictive attendance) is met.

In further embodiments, the system can provide analytics of profit associated with certain events, and project value versus attendance, profit margin, reach, penetration of user population, etc. The system can be configured to automatically determine minimal attendance for break even on candidate events using the various analytics. In some examples, the system automatically enforces a break even attendance minimum before permitting a vendor sponsored event to occur.

Analytics on the system can be enhanced based on targeted survey information. In some settings, the management system is configured to solicit at most two and/or three characterizations of a venue from each user for each visit. Mapping and/or clustering the characteristic descriptions generates venue profiles that more accurately represent how users evaluate a group event or venue (e.g., atmosphere, packed, cheap, quiet, popular, young crowd, old crowd, etc.). In one embodiment, the venue profile screen 900 depicted in FIG. 9 may include a review or survey section that enables the system to solicit reviews or ratings for the venue from the individuals. The individuals may be asked to input two or more characteristics (e.g., loud, classy, crowded, etc.) that best describe the venue. Such characteristics provided for the various venues are tracked and aggregated by the system and allow individuals/group leaders to filter their venue search based on the characteristics in addition to or instead of the overall rating for the venues, thereby increasing efficiency of the venue selection process.

In some embodiments, a similar review or survey section may be provided in the provider profiles (e.g., bartender profiles) that enables the system to solicit reviews or ratings (e.g., characteristics describing the provider and/or overall rating) for the provider from the individuals. The provider profiles may be associated with specific venues and may further improve the venue selection process by providing individuals/group leaders with targeted information about the venues and the providers available at the venues.

In still other aspects, the management system can be configured to promote celebrity attendance at various venues or event groups. In some embodiments, the celebrity must provide permission for the system to announce celebrity events (e.g., basketball team at ______ bar!). Real time views on the system can be filtered to limit exposure where celebrities have not provided authorization.

Example Implementations and Functions

Various embodiments of the management system can implement any one or more of the following features. Some embodiments incorporate various combinations of the various features, and in yet other examples any of the listed features can be provided as extensible features on a core application or system and each of listed features can be activated/installed in various embodiments.

Example Bar Functional Implementation and Club Side Operations
1. “Soft” Check In List for Candidate Event (Expected Check Ins)
   a. System provides the venue a list of “maybes” that they can help convince or help gauge crowd for a candidate event. The system allows people to “soft check in,” which means they are planning on going to said venue, which allows the venues to have a rough estimate of traffic for the day.
   b. Various embodiments can provide this feature to enable access to deals on the system.
   c. In some embodiments, the system provides a dynamic guest list for access to party or event—the group leader can also add guests during the event and have the provider's systems updated in real time to allow new guests entry.
   d. The system can combine expected people with their analytical/historical data to allow for predictive analytics. For example, if a venue expects 100 people and 50% of expected people drink 4 patron shots, then an assumption may be made that the bar will need a minimum of 200 patron shots. Based on this information regarding expected occupancy and estimated number of drinks, the system may dynamically update predicted inventory and staffing levels for the venue/event and communicate the predicted levels to the venues. The communicated information may enable the venue to ensure that accurate inventory and staffing levels are maintained to be able to handle the expected traffic.
   e. The system may maintain a coefficient related to each venue that allows the venue to know its attrition rate.
2. Custom Drink Section functionality—for Example Display Custom Drink Button in UI After Definition
   a. System enables customer to “make” a custom drink (e.g., define customer recipe—communicate same to venue systems responsive to selection in UI—user no longer have to input information like, a dirty martini with 2 olives, instead of 1.
   b. People can preset drink descriptions to allow for faster ordering via mobile devices.
   c. The bartender saves time from having to ask the person to repeat themselves due to factors such as loud noises, forgetting orders, etc. This “custom” drink can then be saved and ordered through any venue. For example, a person might like a dirty martini with 3 olives. Once the “custom” drink is saved, the customized drink option is available across various venues associated with the system, thereby eliminating the need to re-describe the order in every venue.
3. Badge Sub-System
   a. System rewards users with monthly badges for top spending, inviters, explorers, raters, etc.
   b. Increase badge opportunity for strings of positive events, operations, functions, etc.
4. Show how Full the Venue is at the Moment (Dynamic Venue Occupancy)
   a. “Hot Spots” places filling up or that are full.
   b. Currently providing real time feeds, and some embodiments include real time associations with social media information from or at venue.
   c. As users check into venues, they are asked how full the venue is. This may be a sliding scale from 0 to 100%. The system may aggregate the voted information with a weighted bias on more recently checked in people, so the information stays relevant. For example, the system may use a median value and expire votes older than 1 hour.
   d. Users can know the status of venues before even entering a venue. A bar owner can also see, from home, how full their current bars are.
5. “Comp” Menu
   a. Various embodiments are configured to comp users on “a per drink” basis, where the bartender selects, which drinks to comp—system integrations enables venue and/or service provider to select a specific comp options
   b. Other embodiments provide access to new menus dynamically responsive to status determinations
   c. Further embodiments can display a specific comp menus wherein selections from the Comp UI under a certain list are automatically free
   d. Various comp offers can be used by service providers/venues to bid on event groups organized by group leaders
      In some examples, the system includes back end analytic tools for event hosts and can provide valuation heuristics on a group leader or the event group
      Based on predictive valuation of the group, various event hosts can “bid” on the group to select their venue.
      In one example, the system enables multiple forms of such bidding on groups, including first 50 individuals who subscribe get a special comp offer, access to comp menus for at least one drink, free bottle of champagne.
      The comp offers may be conditioned. For example, the comp offer may be displayed as available to the event group, but require a minimum of 10 members of the group to check in to the venue before it can be redeemed. In another example, a UI displayed to the group leader and/or group can convey any condition information and how close the condition is to being satisfied (e.g., one more check in needed).
      In some embodiments, system allows venues to set a maximum number of participants. Once the maximum limit is reached, the comp/deal may be removed from view or closed.
      In other embodiments, comp offers may be conditionally display based on valuation of the group and/or group leader
6. Augmented Analytics Backend
   a. UIs may be provided for users, group leaders, venues, and/or system administrators to study operational/executional data.
7. Voting Sub-System Example
   a. System allow group leaders to take a vote on X amount of venues and see what venues the group wants to go to.
   b. This saves time because it consolidates the choices and allows for an efficient method of selecting a venue based on group leader recommendations.
8. Line Wait Time
   a. System is configured to analyze geolocation to note when people are nearby a venue, but have not checked in, then keep pinging for times to allow an average measure of time waiting.
   b. Shows Users on the venue profiles the average weight time. This is achieved by using geolocation and check in time to see when a user is within X radius and how long it takes them to check in/order. This will then be aggregated to shown a dynamically updated average wait time.
   c. Users/Venue owners can be provided insightful data into how long it takes to get into a venue. An owner may want to try and use the historical data to try and reduce their weight times, while a user can use the data to select venues that won't leave them in line very long.
9. Tip Amount Breakdowns

a. Various embodiments are implemented with a lump sum payment at the end.

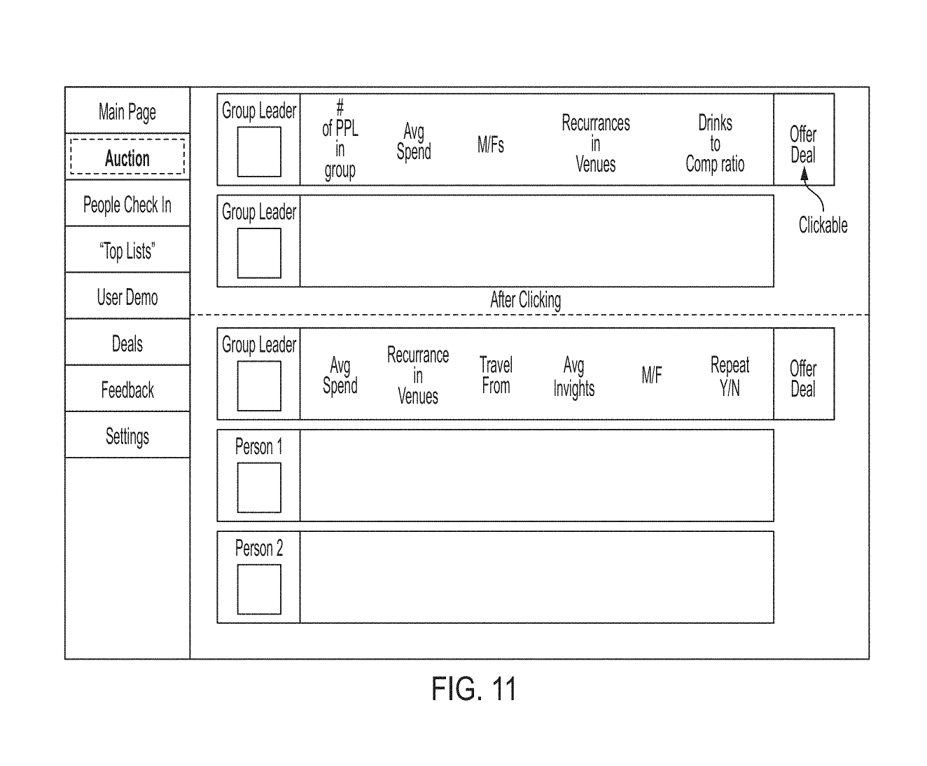

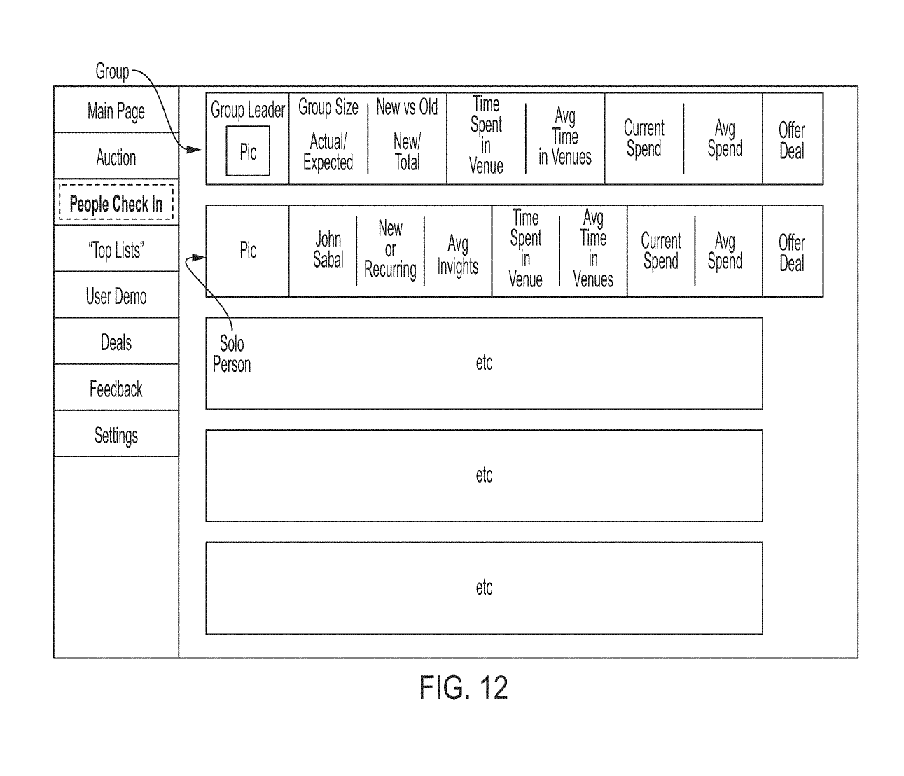

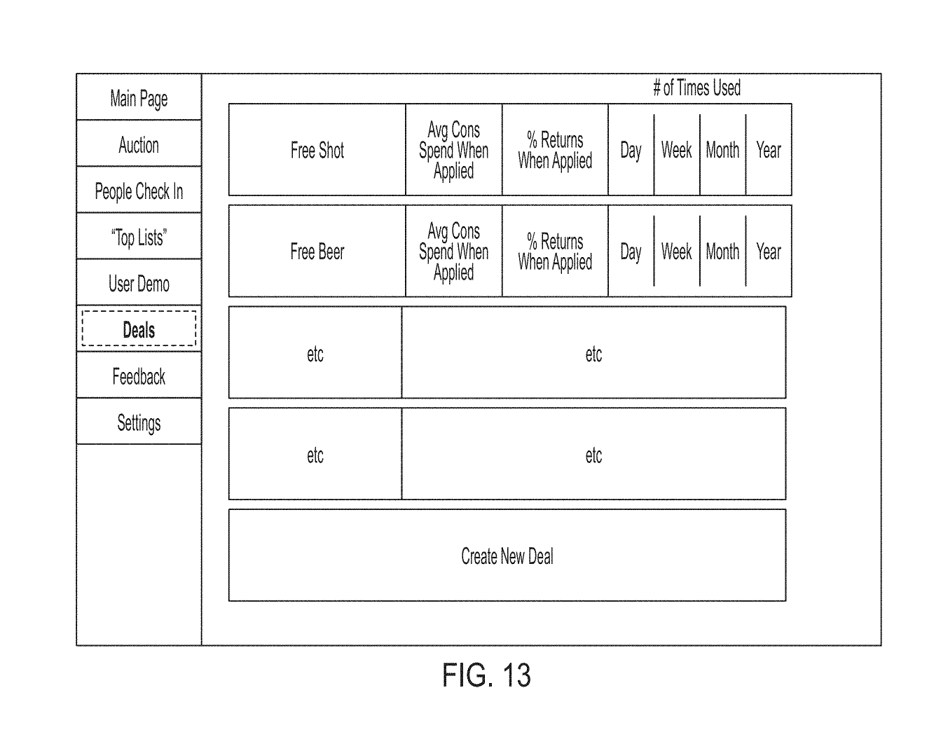

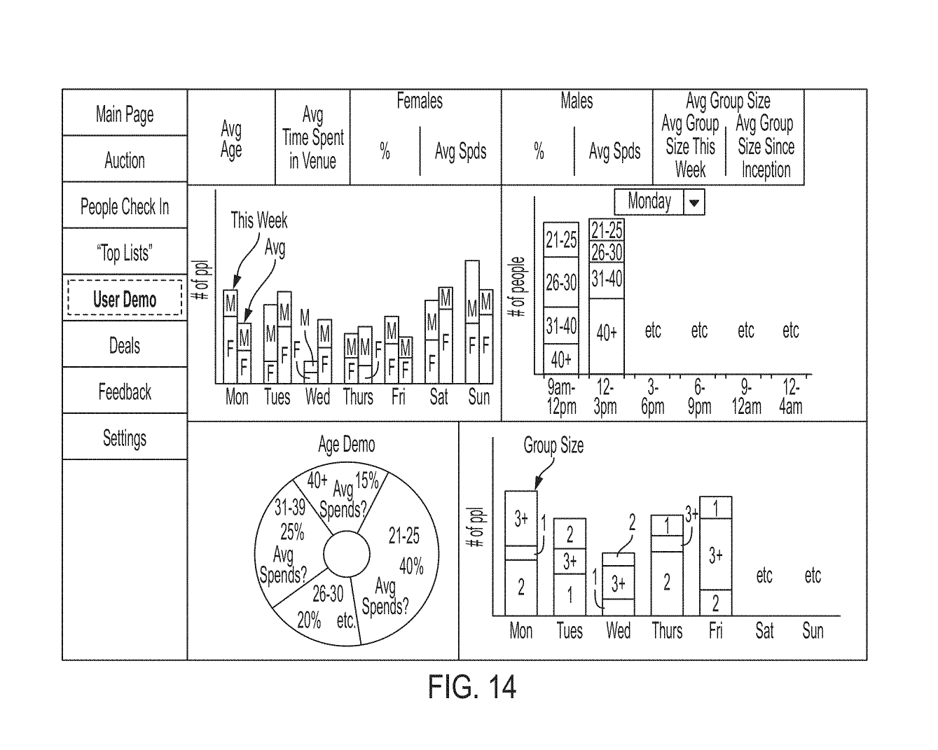

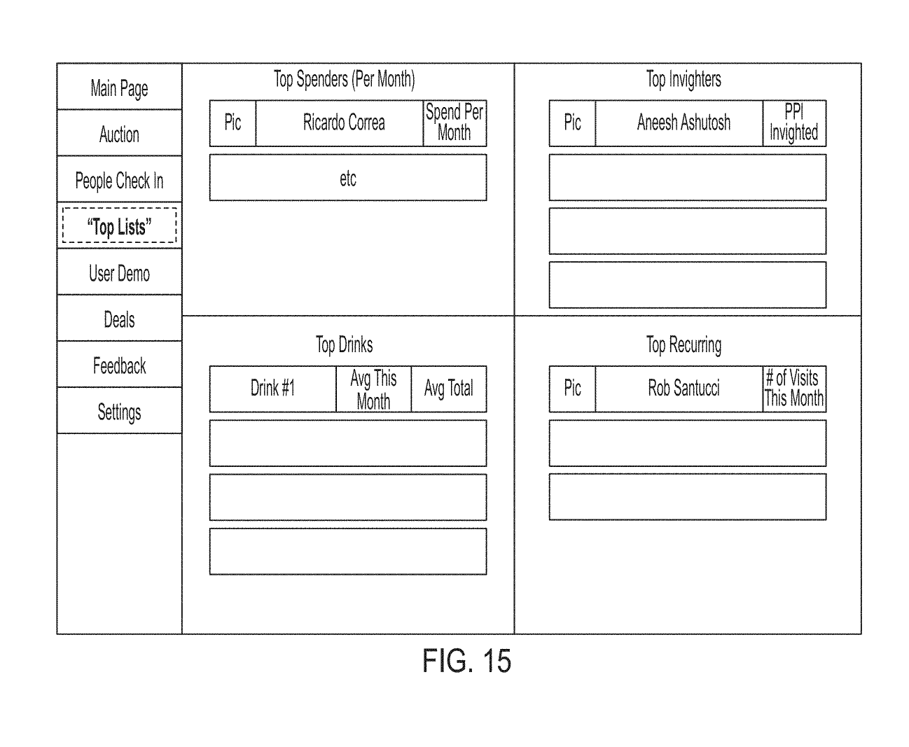

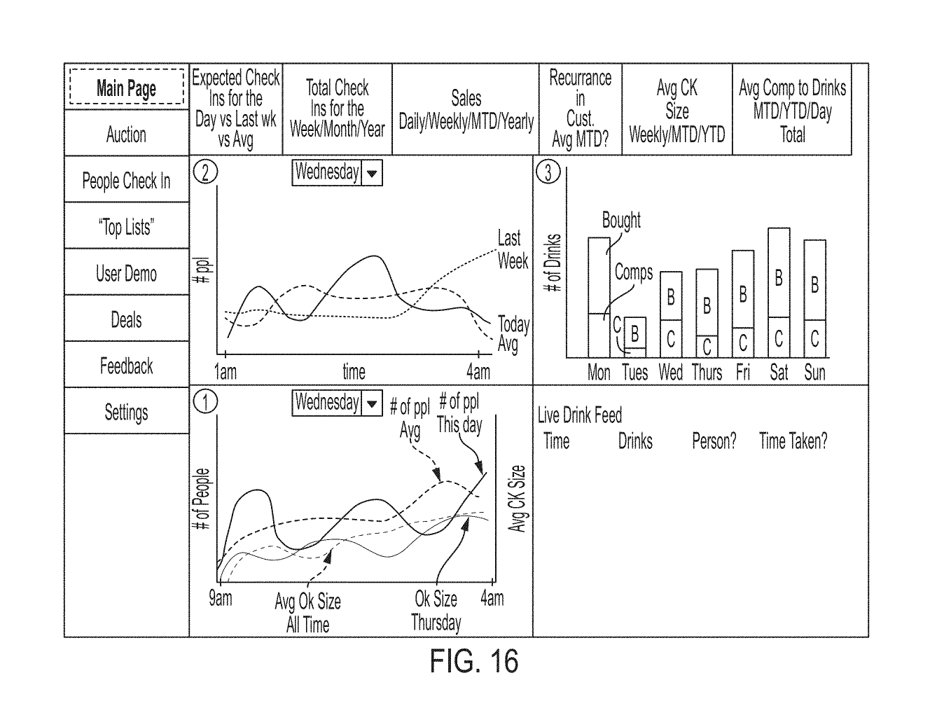

b. Other embodiment enable users to select a lump sum payment or tip as they go.
10. Tracking Group Location
   a. This feature would allow users see where your friends or group participants are within the “map”.
   b. Group location prevents people from constantly asking each other, where the other is.
   c. Tracking may be achieved via APIs built into the user's devices.
11. Review System
   a. In some embodiments, the review system includes at least two parts:
      i. The first is an overall rating system that will allow users to rate the venue's overall experience (e.g., 1-5 stars). This will reset yearly giving venues the opportunity to rebranding themselves.
      ii. The second part is a description voting system, where the user picks one or more (e.g., up to 3) characteristics to describe and rate the venue, then the characteristics get ranked by amount of votes, so everyone on the venue profile can see what that place is most known for. Venues and users can see said information in the venue analytics (for venues) and venue profile page (for both venues and users). The system can be configured to reset monthly or within X time allowing venues to have a clean slate and work on their weaknesses.
   b. Venues will be able to see their strengths and weaknesses. Users can then target/find venues based on characteristics, rather than an overall rating. For example, a user may want a loud music venue on a Friday, but during a business meeting want a more classy quiet environment. The adjective/characteristic reviews may be combined with time of day to show venues what type of guest to expect at what time or day. Venues that have low (staff) votes can also find bartenders that are rated highly to address those issues.
12. Direct Chat with Venue
   a. Allow promoters or group leaders to chat with venue directly to plan events.
13. Web-based Venue Backend
   a. Table reservation system
   b. Venue Analytics
   c. Calendar Management
      i. This should sync into the reservation managers that venues have.
14. Bartender Profiles
   a. Allows for bartenders to make a profile or for the system to create a server profile in other examples. Customers can follow favorite bartenders on the system.
   b. Bartenders can create profiles that allow them to “sync” with venues. Users can also review, follow, and see where bartenders are working on any given day.
   c. The profile allows bartenders to have empirical evidence of their skills. As users follow and rate them, the profile can be updated to visually indicate to bars that they have “1000 followers and specialize in tequila selection,” which could become the new bartending resume. By tracking where and when a bartender works, their schedules can be implemented into an auction allowing venues to find help when short staffed in an easy way.
15. Events Section or Event Channel
   a. The events section may show any events in the area, such as concerts, bands, trivia, etc.
   b. System can dynamically tailor UI displays for users based on preferred events etc.
   c. The Events Channel feature allows anyone to create “Event Pages” that people can follow, then offer deals on these profiles, while taking a commission. For example, someone can create a “jets following” profile and as they build up followers, they can create a “sunday night jets football open bar.” They can pick from preset deals venues offer and fill the minimum person quota. Said promoters may be compensated based on the rates venues post. For example, if a promotor chooses a deal that says “$50 per person Top Shelf open bar, 10% cut with extra 5% if over 60 people,” the promotor could sell the “tickets” on his events profile. These profiles can be made private, so only select people can join. Venues can use this to create “trivia nights” and see if they have the people to create said event before investing into the costs of creating such event. Once an event is posted, users may sign up and won't be charged until the minimum amount of people accept the deal.
   d. Currently, promoters can only be at one location to do sales and make money. With the improved system, they can manage multiple locations. Venues only have social networking sites, which travelers, and non-social media advocates do not use. This will allow everyone to have one consolidated place to search for venue or event deals. This system also allows for easier group booking, while allowing venues to collect revenues before events.
16. Surveys
   a. Allow consumers to take surveys for points and charge venues. Allows the venues to create surveys to ask consumers that have checked in questions. The system allows a venue to ask questions to people actually attending their venues, rather than a mass of followers, who may not even be return customers. This also allows venues to see if they have a viable idea without implementing high costs. For example, a bar can see if their customers would attend a brunch and figure out a price point without buying a single ounce of food.
17. API to integrate Uber/Lyft Link
   a. Promotional link to give more revenues, when people end their night the system will ask them if they need a ride.
   b. In some embodiments, the system can identify how many drinks a user has ordered and recommend ride services accordingly.
18. Preorders
   a. Allows users to order food/drinks before they even walk into the venue.
   b. Allows for quicker service and combined with predictive analytics performed by the system, venues will be able to properly keep inventory levels to avoid shortages.
19. VIP Feature
   a. System enables user to pay an extra cover for perks, such as faster service, exclusive sections, more points, etc.
   b. In some examples, people with tables should automatically get VIP service.
   c. Allows users to purchase a middle tier VIP service that will give them a priority service over other customers.
   d. Currently, VIP is a binary concept. Either you have table service or you don't. The improved system allows people who don't have a table to purchase priority service. This is done by moving said people to the top of a mobile ordering list. This allows the venues to charge a minimum cover per head and make additional revenue they could not have without the system.
20. Flexible Analytics
   a. Allow venues to make their own charts and such. For example, the venue can map profit per user, per event, per group, etc.
21. Point System Sway
   a. Using check in points to move crowd to different locations and allow for traffic control.
   b. In some embodiments, the system is configured to offer more points to users checking in a lower occupancy venues—among other options where the system influences the user population based on increasing awards.
   c. Move crowds into slow bars by giving them additional reward points (e.g., set by the venue) if they go.
   d. By combining the reward system, venue occupancy data, and user data, the system can dynamically determine slow bars that the users may like and can move users into those slow bars. Conventional systems do not utilize such information. The improved system, however, can efficiently manage the spreading of users across venues.
22. Suggestions Algorithm Examples
   a. System generates suggestions based on likes and such. For example—if a user (e.g., Rob) and another user (e.g., Aneesh) both like tequila, edm, lower east side, etc. . . . then one use case—Rob should get a suggestion for the places Aneesh likes and vice versa from the system.
23. Live Pic/Video Updates by Venue
   a. Various embodiments of the system/application are configured to enable venues to post live or current pictures or videos of the venue.
   b. system provides for venue based users and/or interaction between venue applications and communication streams for group/event participants.
24. Industry Reports for Areas, Venues, Service Providers, etc.
   a. System is configured to generate displays of analytic reporting to vendor users. Various examples include data analytics based on locations (e.g., macro analytics vs micro). The vendor users can tailor their reports and receive updated analytics based on any customizations.
25. Premium Positioning Enhancement
   a. Charge venues for top X spots in search results and/or offering listings to group leaders. The system is configured to accept ordering information for returning relevant results to participants/groups/group leaders.
26. Performer or Entertainment Interface/Channel for Management System
   a. Performer Interface configured to, for example, allow DJs and artist to have a booking engine for gigs.
   b. Within the Performer Interface system enables crowds to, for example, make song requests or communicate directly with the performer.
   c. Performer or Entertainment profile may be similar to the bartender profile.
   d. Can be tied into the auction to find entertainment with preset prices and combined with analytics to allow venues to see which entertainer makes most sense for them.
27. Corporate Accounts Feature
   a. Target corporation user/group leaders to increase integration and is some setting target offers or comp packages to corporate clients and respective entertainment budgets.
28. Deeper POS Integration
   a. Various APIs provide seamless integration with vendor systems. In some embodiments, status information and integration identifiers can be configured to trigger enhanced functions provided by POS system. In some examples, the management system can be configured to activate functionality available on given POS that is not currently utilized by a vendor.
29. Pub Crawl and Such Events
   a. Trivia events and topics displayed to group leaders, users, etc.
   b. Manage scavenger hunt events through the management system. For example, system can match find list to user location and automatically craft a scavenger hunt event for teams or individual users to participate in.
   c. The system can create pub crawls that use occupancy information to keep bars from becoming grossly overpopulated.
   d. Currently, pub crawls allow customers to go to select bars, while sometimes limiting the hours they can attend certain venues. The improved system can use occupancy information to dynamically route customers to less occupied venues allowing for a more controlled and fluid pub crawl event.
30. Restaurant Space Integration Example
   a. In some embodiments, POS tie in can be extended to pother fulfillment systems, and specifically within the context of restaurant support systems. For example, deeper integration can be coupled with groups/events requesting specific provider (e.g., waitress) at a venue, specific accommodations, times, etc.
31. Interactive Games Management Example
   a. In one example, similar to a trivia event—the management system provides functions to execute interactive gaming sessions, and/or manage game functions across an event group.
32. Celebrities in the “Who Has Been Here?” Section and Associated Displays
33. Random Groups
   a. Various embodiments support a find a group feature (e.g., user can toggle ok to add member settings on request—to permit additional participant requests (e.g., to achieve a free offer requiring a minimum number of participants, etc.).
   b. In another example, system groups users responsive to a find me a group or build me a group selection in the user interface.
   c. Allow single/small groups to be combined into larger groups.
   d. This will allow for individuals/smaller groups to reap the benefits of a larger group. This also allows venues to sell multiple tables in quickly without the headaches of dealing with longlines, promoters, etc.
   e. The groups are dynamically created and destroyed. Message history is saved for one month, and inactive groups are automatically pruned, thereby significantly reducing data/storage resources usage.
34. User Interface Embodiments
   a. In some examples, users and/or group leaders need to review a number of venues in close proximity and in large volume before selecting the venue for an event. According to one embodiment, the user interface can be configured to display venue profiles and enable scrollable access to the venues images without having to transition the UI to a full screen view of the venue. Conceptually, the functionality enables the user to access venue images without having to select the actual venue. From the user experience perspective, instead of having to click the picture and have the UI change to a full screen of the pictures, the user can simple scroll through the venues list of pictures without exiting the venue profile. In one example, a picture window can appear responsive to a hover event on a venue and the picture window can include navigation options for scrolling through the displayed images. This allows the user to efficiently view the various images without having to separately navigate through multiple images.
35. Auctioning System
   a. According to various embodiments, the system is configured to enable hosts or venues to bid on various event groups.
   b. Bidding can be implemented in some settings as a comp offer for a given group or leader.
   c. In other examples, bidding for groups can include time or participation limits (e.g., first 50 groups or 500 people whichever occurs first, etc.)
   d. Bidding functions can be configured to display valuations of the event group or group leader and provide valuation information to enable event hosts to tailor comp offers.
   e. In further examples, valuation can be used by the system to automatically provide access to comp offers based on qualifying settings set by event hosts on the system.
   f. The system allow venues to offer customers deals directly with no middlemen.
   g. Currently, venues advertise on social media, but have no way efficient way of tracking who came from what source. The improved system allows the venues to take those costs and offer them to their customers directly, rather than paying for advertising. The system can be dynamically changed to show groups open for deals, events for sale, available bartenders, available entertainers, etc.
   h. To determine which auctions or venues are most relevant to the user, the system first sorts them by location, then by tracked user preference; e.g., if a user does not like wine but likes beer, the system is more likely to show a venue with great beer 10 blocks away than a place with great wine that's 5 blocks away.
36. Grouping
   a. This feature allows users to make groups to plan out events. It creates a temporary group chat and allows them to vote, split tabs, see who's checked in, who's checked out, location of other group members, etc.
   b. Greatly simplifies the process of going out by allowing users to have one application that does everything for them. This combined with analytics allows venues to see dynamically changing aggregated information on groups based on historical data. For example, as group members get added the information for the group changes allowing a venue to make informed decisions on precisely what deals to offer certain groups.
   c. The system reduces the data/storage resources usage by de-duplicating duplicate groups and aggregating individual data on the fly. For example, if the same people are in multiple groups, the system reuses existing groups. Also, as people mark themselves as leaving or exiting from the group, the system hides them in the group but does not remove them or make new groups so as to allow reuse. In some instances, for multiple groups comprising of mostly same individuals, the system may maintain information associated with a first group, and for the other similar groups, only maintain information associated with differences between the similar groups and the first group. In this way, the efficiency of the system is improved as fewer data/storage resources are needed in comparison to conventional systems where duplicate data for all groups is maintained.
37. Mobile Ordering
   a. Allow users to order their drinks via mobile devices
   b. Increases efficiencies, orders won't clear until payment does, allows venues to have drink analytics by hour/customers.
   c. Integration or interaction with the venue POS system (e.g., viewing items on the menu) may be achieved via an API.
38. Deals
   a. The system allows users to view the deals that are being offered near them, which can include deals venues offer everyone or deals specifically offered to them.
   b. One consolidated place to see deals for use, while hiding the complexities of the system.
   c. To determine which deals or venues are most relevant to the user, the system first sorts them by location, then by tracked user preference; e.g., if a user does not like wine but likes beer, the system is more likely to show a venue with great beer 10 blocks away than a place with great wine that's 5 blocks away.
39. UI Change After Check in
   a. When a user checks in, their UI changes to a simple display that shows information that's relevant to that venue such as menus, who has checked in form their group, etc.
   b. A smart changing UI allows for the simplification of a complex system. Uses bright or contrasting colors to draw users to the important parts of the ordering/checkout process, to provide for an efficient UI that is easy to use even when customers are inebriated.
40. Dynamic Guest List
   a. Give venues a dynamically updating list of who is coming for what event and their pictures.
   b. Currently, venues need to print out separate sheets of paper for each event and keep track of who is in by manually crossing them off. The improved system allow venues to have a dynamically changing list with pictures to easily identify who is who.
41. Traffic Analytics
   a. Venues will be able to see who has frequently walked by/near their venues. Allow them to target those individuals. The system can generate and provide a suggested list of people to the venue based on geolocation, user's preferences, and venue reviews/ratings.
   b. A venue has no way of knowing if someone that fits their venue's “vibe” has walked by. This allows them to target nearby individuals and draw them in with deals.
   c. To estimate how many people are at a venue at a given time the system may use the customer check-in count and extrapolate from there based on a coefficient for each venue that tracks how often people commit and don't show up. Traffic-by-time data obtained via a web mapping service may also be used.
42. Analytics
   a. Provide useful analytics to help venue owners better understand their business, increase return on investment, and understand their demographics.
   b. Venue owners can begin to target customers based on day, hour, and potential customers.
   c. FIG. 11 is an example UI that provides venues relevant information about the group (e.g., number of people in the group, average amount spent by the group, number of males and females in the group, how often the group visits the venue, and drink to comp ratio indicative of the number of drinks the group tends to buy when offered 1 comp) to enable the venues to determine which deals (e.g., most profitable deals) to offer to the group. Once the deal is clicked, detailed information associated with the individuals in the group is presented.
   d. FIG. 12 is an example UI that provides venues (e.g. bar owners) a snapshot of individuals or groups who are currently checked in the venue. The information in the UI may be generated through data and behavioral analytics. The information may include dynamically updated information for the group/user (e.g., how much time a particular group/user has spent at the venue and current spend for the group/user) and behavioral or historical information for the group/user (e.g., average spend for the group/user, average time spent at venues for the group/user). The venue may offer specific deals or offers based on this information. For example, if the current spend for a user is $15 and he is known to spend $50 on an average, the venue may decide to offer a deal to the user to prompt him to increase his spend amount. In another example, if the time that a group spent at the venue is lower than the average time spent by the group at venues, the venue may decide to offer a deal to the group to prompt them to revisit.
   e. FIG. 13 is an example UI that allows venues to create deals or offers, view associated analytics, and determine based on the analytics which deals to offer to people/groups in auctions or to people/groups currently at the venue.
   f. FIG. 14 is an example UI that provides demographics information, such as number of males vs females visiting a venue on a particular day, the age group of people visiting the venue at a certain time of day, average group size for a particular day or week, etc. Such information may be used to target or tailor the menus, deals, or other offerings to customers. For example, if 80% men visit the venue on Mondays, more deals relating to beer may be offered on Mondays. In another example, if primarily women visit the venue on Thursdays, deals may be offered for a ladies night.
   g. FIG. 15 is an example UI that provides historical information, such as, list of top 10 people who spend the most at a venue, top 10 people who invite the most people to the venue, top 10 drinks bought by people visiting the venue, and top 10 people who are frequent and recurring visitors. Such information may be used to tailor the rewards, points, deals, and/or loyalty programs offered to the users. It will be appreciated that although FIG. 15 depicts various metrics measured on a monthly basis, other time intervals (e.g., per visit, weekly, daily, annually, etc.) may be used without departing from the scope of this disclosure.
   h. FIG. 16 is an example UI that displays summary data providing a high-level overview of various aspects of the venue's business, such as comparisons between current and historical sales, check ins, group sizes, etc.

It will be appreciated that various features described above may be combined to create powerful insights into a business. For example, by combining expected check ins with user analytics, the system can predict inventory levels that a venue might need. Combining line wait, group tracking, and venue occupancy, a group can see what venues are at specific occupancy levels and choose one that fits their needs best. Combining bartender adjectives or reviews and profile/venue adjectives or reviews, a venue can help hire a bartender tailored to their weaknesses to improve reviews in those areas.

### Example System Implementation and Interaction

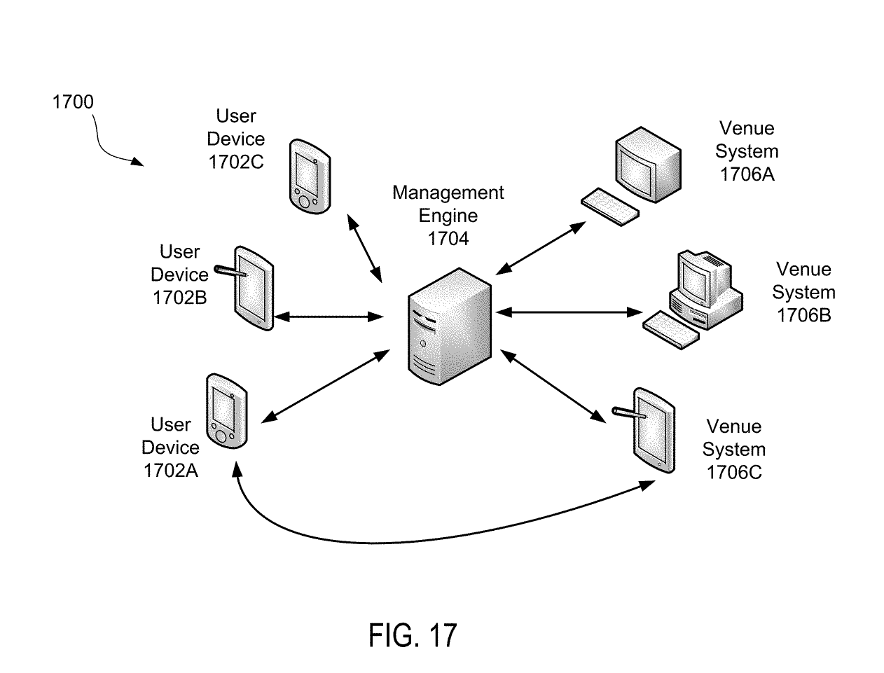

In some embodiments, the management system can include various components that interact with one another to implement the various functions and features described herein. FIG. 17 is a block diagram of an example event management system 1700. The system can include one or more user devices 1702A-C, management engine 1704, and one or more venue systems 1706A-C. Group leaders, promoters, and/or participants may use user devices 1702A-C to interact with management engine 1704 and/or venue systems 1706A-C via, for example, mobile applications executing on the user devices. For instance, user device 1702A may be a smart phone and user device 1702B may be a tablet computer that are respectively used by a group leader and promoter to build or organize groups and events, manage participants and enable direct communication with participants and/or venue systems 1706A-C. In some embodiments, user device 1702C may be a smart phone and may be used by a participant to interact with groups.

According to one embodiment, the management engine 1704 includes one or more frontend systems and/or one or more backend systems. For instance, the management engine may include a frontend system configured to interact with user devices (e.g., the illustrative user device 1702A-C). Additionally, or alternatively, the management engine may include a backend system configured to interact with venue systems (e.g., the illustrative venue systems 1706A-C) and to host a backend of an application providing the venue-based functions and/or features described herein. The application may be accessed over the Internet and may include a web-based interface via which any changes or updates to the functions or features can be readily and seamlessly implemented.

The venue systems 1706A-C may include venue POS systems, reservation systems, ordering systems, and/or other venue-based systems associated with one or more venues that have registered with the system.

In some implementations, a group leader or promoter, via a user device (e.g., user device 1702A), may provide group and/or event related information to the management engine 1704. The group and/or event related information may include type of event, selected venue for event, invited participants, selected payment options for the event, payment information/tabs for the group, accepted offers, placed orders by members of the group, service or provider requests, and/or other information. In response to receiving the group information, the management engine 1704 may establish communication with one or more venue systems 1706A-C associated with the selected venue and communicate at least a portion of the group/event information (e.g., placed orders including custom orders, accepted offers, tabs, provider requests, etc.) to the one or more venue systems. The management engine 1704 may trigger execution of requested functionality (e.g., drink order, food order, service request etc.) on the one or more venue systems. In one embodiment, the management engine 1704 may access fulfilment information (e.g., provider details, bartender information, occupancy information, comp offerings, menu selection, options for service upgrades, etc.) on the one or more venue systems.

According to one aspect, through the interaction between the management engine and vendor systems, all group activity may be tracked to, for example, offer additional and/or alternative deals or offers to the group. The tracked information may be stored in the backend system and used to update the group leader/participant profiles to, for example, provide updated information on placed orders and associated charges for each participant.

In some embodiments, the management engine may enable any user device 1702A-C associated with a member/participant of the group to access and execute functionality on the one or more venue systems.

Various aspects and functions described herein may be implemented as specialized hardware or software components executing processors of one or more specialized computer systems. Which can include mobile computing devices (e.g., smart phones, tablet computers, and personal digital assistants) and network equipment (e.g., load balancers, routers, and switches). Examples of particular models of mobile computing devices include iPhones, iPads, and iPod Touches running iOS operating systems available from Apple, Android devices like Samsung Galaxy Series, LG Nexus, and Motorola Droid X, Blackberry devices available from Blackberry Limited, and Windows Phone devices. Further, aspects may be located on a single computer system or may be distributed among a plurality of computer systems connected to one or more communications networks.

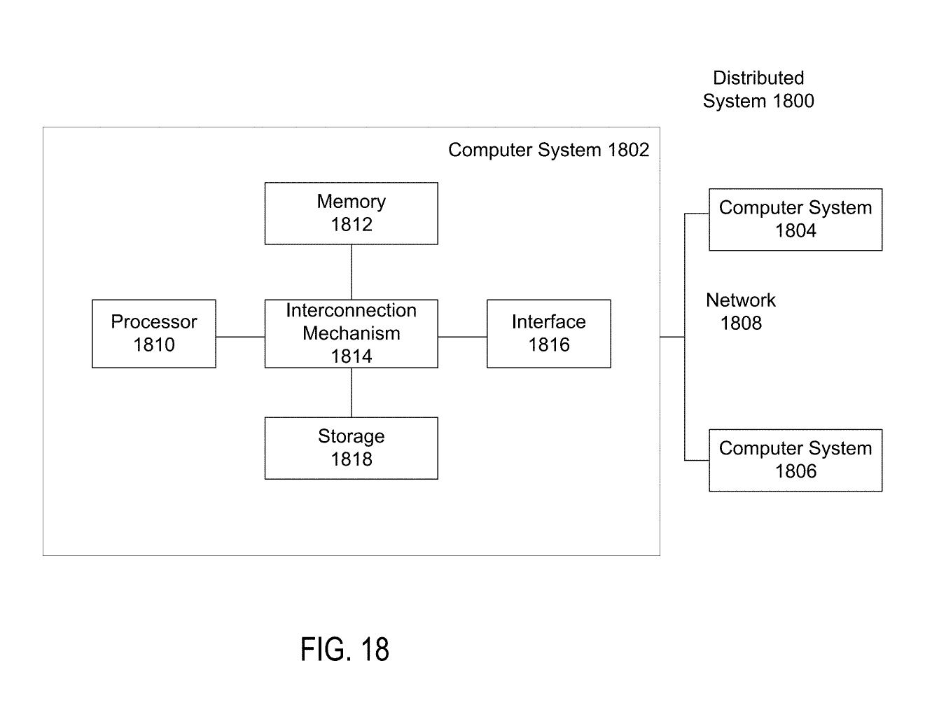

For example, various aspects, functions, and processes may be distributed among one or more computer systems configured to provide a service to one or more client computers, or to perform an overall task as part of a distributed system, such as the distributed computer system 1800 shown in FIG. 18. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 18, there is illustrated a block diagram of a special purposed distributed computer system 1800, in which various aspects and functions are practiced. As shown, the distributed computer system 1800 includes one or more computer systems that exchange information. More specifically, the distributed computer system 1800 includes computer systems 1802, 1804, and 1806. As shown, the computer systems 1802, 1804, and 1806 are interconnected by, and may exchange data through, a communication network 1808. The network 1808 may include any communication network through which computer systems may exchange data. To exchange data using the network 1808, the computer systems 1802, 1804, and 1806 and the network 1808 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS2, JSON, SOAP, CORBA, REST, and Web Services. To ensure data transfer is secure, the computer systems 1802, 1804, and 1806 may transmit data via the network 1808 using a variety of security measures including, for example, SSL or VPN technologies. While the distributed computer system 1800 illustrates three networked computer systems, the distributed computer system 1800 is not so limited and may include any number of computer systems and computing devices, networked using any medium and communication protocol.

As illustrated in FIG. 18, the computer system 1802 includes a processor 1810, a memory 1812, an interconnection element 1814, an interface 1816 and data storage element 1818. To implement at least some of the aspects, functions, and processes disclosed herein, the processor 1810 performs a series of instructions that result in manipulated data. The processor 1810 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 1810 is connected to other system components, including one or more memory devices 1812, by the interconnection element 1814.

The memory 1812 stores programs (e.g., sequences of instructions coded to be executable by the processor 1810) and data during operation of the computer system 1802. Thus, the memory 1812 may be a relatively high performance, volatile, random access memory such as a dynamic random access memory (“DRAM”) or static memory (“SRAM”). However, the memory 1812 may include any device for storing data, such as a disk drive or other nonvolatile storage device. Various examples may organize the memory 1812 into particularized and, in some cases, unique structures to perform the functions disclosed herein. These data structures may be sized and organized to store values for particular data and types of data.

Components of the computer system 1802 are coupled by an interconnection element such as the interconnection element 1814. The interconnection element 1814 may include any communication coupling between system components such as one or more physical busses in conformance with specialized or standard computing bus technologies such as IDE, SCSI, PCI and InfiniBand. The interconnection element 1814 enables communications, including instructions and data, to be exchanged between system components of the computer system 1802.

The computer system 1802 also includes one or more interface devices 1816 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 1802 to exchange information and to communicate with external entities, such as users and other systems.

The data storage element 1818 includes a computer readable and writeable nonvolatile, or non-transitory, data storage medium in which instructions are stored that define a program or other object that is executed by the processor 1810. The data storage element 1818 also may include information that is recorded, on or in, the medium, and that is processed by the processor 1810 during execution of the program. More specifically, the information may be stored in one or more data structures specifically configured to conserve storage space or increase data exchange performance. The instructions may be persistently stored as encoded signals, and the instructions may cause the processor 1810 to perform any of the functions described herein. The medium may, for example, be optical disk, magnetic disk or flash memory, among others. In operation, the processor 1810 or some other controller causes data to be read from the nonvolatile recording medium into another memory, such as the memory 1812, that allows for faster access to the information by the processor 1810 than does the storage medium included in the data storage element 1818. The memory may be located in the data storage element 1818 or in the memory 1812, however, the processor 1810 manipulates the data within the memory, and then copies the data to the storage medium associated with the data storage element 1818 after processing is completed. A variety of components may manage data movement between the storage medium and other memory elements and examples are not limited to particular data management components. Further, examples are not limited to a particular memory system or data storage system.

Although the computer system 1802 is shown by way of example as one type of computer system upon which various aspects and functions may be practiced, aspects and functions are not limited to being implemented on the computer system 1802 as shown in FIG. 18. Various aspects and functions may be practiced on one or more computers having a different architectures or components than that shown in FIG. 18. For instance, the computer system 1802 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 1802 may be a computer system including an operating system that manages at least a portion of the hardware elements included in the computer system 1702. In some examples, a processor or controller, such as the processor 1810, executes an operating system. Examples of a particular operating system that may be executed include a Windows-based operating system, such as, the Windows-based operating systems, available from the Microsoft Corporation, a MAC OS System X operating system or an iOS operating system available from Apple Computer, one of many Linux-based operating system distributions, for example, the Enterprise Linux operating system available from Red Hat Inc., or a UNIX operating system available from various sources. Many other operating systems may be used, and examples are not limited to any particular operating system.

The processor 1810 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Java, C++, C# (C-Sharp), Python, JavaScript, React, Node.js, or MongoDB. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components. Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture or programming language.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements.

The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Use of at least one of and a list of elements (e.g., A, B, C) is intended to cover any one selection from A, B, C (e.g., A), any two selections from A, B, C (e.g., A and B), any three selections (e.g., A, B, C), etc., and any multiples of each selection. Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A data management system comprising:
at least one processor operatively connected to a memory, the at least one processor configured to execute a plurality of system components:
an event data container generation component, executed by the at least one processor configured to accept definition of a data container for a group event, manage objects associated with the data container reflecting invitations to the group event, and define an object specifying a venue associated with the group event;
a communication component, executed by the at least one processor, configured to define a private communication channel permissioned based on matching data objects; and
an integration component, executed by the at least one processor, configured to:
establish communication with one or more local architecture execution systems;
trigger execution of requested functionality on the one or more local architecture execution systems;
access execution information on the one or more local architecture execution systems; and
enable at least one device associated with at least one data object in the data container to access and execute functionality on the one or more local architecture execution systems through the integration component.

2. The data management system of claim 1, wherein the communication component is configured to limit communication functions within the private communication channel to objects associated with the data container reflecting acceptances to the invitations to the group event.

3. The data management system of claim 1, wherein the communication component is configured to automatically terminate communication functionality based on a threshold time period after the event.

4. The data management system of claim 1, further comprising a user interface component configured to generate displays for accepting definition of the data container for the event, the definition comprising one or more of date, time, venue, and list of objects associated with the data container reflecting invitations to the group event.

5. The data management system of claim 1, wherein the user interface component is configured to modify default displays on the at least one device responsive to determining temporal thresholds associated with the event are met.

6. The data management system of claim 5, wherein the user interface component is configured to generate displays relating to the object specifying the venue associated with the group event on the at least one device.

7. The data management system of claim 1, further comprising a customization component configured to accept customizations for triggering customized functionality on the one or more local architecture execution systems.

8. The data management system of claim 7, further comprising a user interface component configured to dynamically generate user interface elements associated with the customizations, that are responsive to selection in the user interface to trigger the customized functionality on the one or more local architecture execution systems.

9. The data management system of claim 1, further comprising an analytic component configured to provide summary data or machine learning patterns on event group data.
